(19) United States
(12) Patent Application Publication
(10) Pub. No.: US 2012/0072089 A1
(43) Pub. Date: Mar. 22, 2012

(54) VEHICLE GROUP CONTROL METHOD AND VEHICLE

(75) Inventors: Yusuke Nemoto, Susono-shi (JP); Mitsuhisa Shida, Fuji-shi (JP)

(73) Assignee: TOYOTA JIDOSHA KABUSHIKI KAISHA, TOYOTA-SHI, AICHI (JP)

(21) Appl. No.: 13/003,667

(22) PCT Filed: May 11, 2009
(86) PCT No.: PCT/JP2009/058768

§ 371 Date: Jan. 11, 2011

(51) Int. Cl. G08G 1/00; B60K 31/00

(52) U.S. Cl. 701/96

(57) ABSTRACT

Disclosed is a vehicle group control method which controls traveling of a vehicle group having n vehicles (where n=2, 3, . . . ). In extending the inter-vehicle distance between a (j−1)th vehicle from the front and a j-th vehicle (where j=2, 3, . . . , n) within the vehicle group, the relative speed of the j-th vehicle with respect to the (j−1)th vehicle during the changing of the inter-vehicle distance is changed as indicated by a graph with a minimum value on a time axis.

### TECHNICAL FIELD

The present invention relates to a vehicle group control method which controls traveling of a vehicle group having a plurality of vehicles, and a vehicle including such vehicle group control means.

### BACKGROUND ART

In the related art, as a technique of this field, a traveling control device is known which is described in Japanese Unexamined Patent Application Publication No. 2001-344686. In a service zone where a vehicle group can be traveling, this device performs communication with preceding vehicles and/or succeeding vehicles and communication instruments in road facilities and causes the host vehicle to travel in a state where the host vehicle and the vehicles form a vehicle group. In this device, when the distance up to the end site of the service zone is smaller than a predetermined distance, a target inter-vehicle distance from a preceding vehicle which is traveling immediately before the host vehicle is changed, ensuring smooth traffic at the end site of the service zone.

### CITATION LIST

### Patent Literature

[Patent Literature 1] Japanese Unexamined Patent Application Publication No. 2001-344686

### SUMMARY OF INVENTION

### Technical Problem

As described above, at the time of vehicle group traveling, it is necessary to change the inter-vehicle distance between the vehicles forming the vehicle group when the service zone where the vehicle group can be traveling ends or when a vehicle joins or leaves the vehicle group. In the traveling control device of Patent Literature 1, the vehicle speed is controlled to extend the inter-vehicle distance, but there is no description as to the relative speed or relative acceleration between the vehicles. In this case, there is a problem in smoothness of a variation in the relative vehicle speed or control accuracy while the inter-vehicle distance is changed.

An object of the invention is to provide a vehicle group control method and a vehicle capable of accurately changing an inter-vehicle distance with a smooth variation in a relative vehicle speed at the time of vehicle group traveling.

### Solution to Problem

The invention provides a vehicle group control method which controls traveling of a vehicle group having n vehicles (where n=2, 3, . . . ). In extending the inter-vehicle distance between a (j−1)th vehicle from the front and a j-th vehicle (where j=2, 3, . . . , n) within the vehicle group, the relative speed of the j-th vehicle with respect to the (j−1)th vehicle during the changing of the inter-vehicle distance is changed as indicated by a graph with a minimum value on a time axis.

With this vehicle group control method, in extending the inter-vehicle distance between the (j−1)th vehicle and the j-th vehicle, the relative speed of the j-th vehicle with respect to the (j−1)th vehicle is changed smoothly as indicated by a graph with a minimum value on a time axis. Therefore, it is possible to accurately extend the inter-vehicle distance with a smooth variation in the relative speed.

The invention also provides a vehicle group control method which controls traveling of a vehicle group having n vehicles (where n=2, 3, . . . ). In reducing the inter-vehicle distance between a (j−1)th vehicle from the front and a j-th vehicle (where j=2, 3, . . . , n) within the vehicle group, the relative speed of the j-th vehicle with respect to the (j−1)th vehicle during the changing of the inter-vehicle distance is changed as indicated by a graph with a maximum value on a time axis.

With this vehicle group control method, in reducing the inter-vehicle distance between the (j−1)th vehicle and the j-th vehicle, the relative speed of the j-th vehicle with respect to the (j−1)th vehicle is changed smoothly as indicated by a graph with a maximum value on a time axis. Therefore, it is possible to accurately reduce the inter-vehicle distance with a smooth variation in the relative speed.

In the vehicle group control method of the invention, in changing all the inter-vehicle distances within the vehicle group by a predetermined variation, the time for changing the inter-vehicle distance may be determined on the basis of the number of vehicles, the predetermined variation, and the vehicle speed of a leading vehicle of the vehicle group.

In changing all the inter-vehicle distances within the vehicle group, in particular, there is a possibility that, with regard to vehicles near both ends of the vehicle group (the head or tail of the vehicle group), a great variation in speed is necessary. Thus, a burden imposed on the vehicles at both ends of the vehicle group may increase undesirably. In contrast, with the above-described vehicle group control method, the time for changing the inter-vehicle distance is determined on the basis of the number of vehicles, the predetermined variation, and the vehicle speed of the leading vehicle of the vehicle group. Therefore, the time for changing the inter-vehicle distance is adjusted to be long, making it possible to suppress a burden on the vehicle.

In the vehicle group control method of the invention, in extending the inter-vehicle distance within the vehicle group, in a vehicle before a predetermined reference position between the leading vehicle and the trailing vehicle of the vehicle group, the vehicle speed during the changing of the inter-vehicle distance of the relevant vehicle may be changed as indicated by a graph with a maximum value on a time axis, and in a vehicle behind the predetermined reference position, the vehicle speed during the changing of the inter-vehicle distance of the relevant vehicle may be changed as indicated by a graph with a minimum value on a time axis.

With this vehicle group control method, the vehicle speed of a vehicle before the reference position is indicated by a graph with a maximum value on a time axis, such that a vehicle before the reference position moves to be separated in the forward direction from the reference position within the vehicle group. The vehicle speed of a vehicle behind the reference position is indicated by a graph with a minimum value on a time axis, such that a vehicle behind the reference position moves to be separated in the rearward direction from the reference position within the vehicle group. The reference position is between the leading vehicle and the trailing vehicle of the vehicle group. Thus, within the vehicle group, each vehicle moves to be separated from the reference position within the vehicle group, such that the inter-vehicle distance within the vehicle group is extended. Therefore, it is possible to reduce movement of vehicles near both ends of the vehicle group and to reduce the time for extending the inter-vehicle distance while suppressing a burden of acceleration/deceleration on vehicles near both ends of the vehicle.

In the vehicle group control method of the invention, in reducing the inter-vehicle distance within the vehicle group, in a vehicle before a predetermined reference position between the leading vehicle and the trailing vehicle of the vehicle group, the vehicle speed during the changing of the inter-vehicle distance of the relevant vehicle may be changed as indicated by a graph with a minimum value on a time axis, and in a vehicle behind the predetermined reference position, the vehicle speed during the changing of the inter-vehicle speed of the relevant vehicle may be changed as indicated by a graph with a maximum value on a time axis.

With this vehicle group control method, the vehicle speed of a vehicle before the reference position is indicated by a graph with a minimum value on a time axis, such that a vehicle before the reference position moves rearward to approach the reference position within the vehicle group. The vehicle speed of a vehicle behind the reference position is indicated by a graph with a maximum value on a time axis, such that a vehicle behind the reference position moves forward to approach the reference position within the vehicle group. The reference position is between the leading vehicle and the trailing vehicle within the vehicle group. Thus, within the vehicle group, each vehicle moves to be gathered at the reference position within the vehicle group, such that the inter-vehicle distance within the vehicle group is reduced. Therefore, it is possible to reduce movement of vehicles near both ends of the vehicle group and to reduce the time for reducing the inter-vehicle distance while suppressing a burden of acceleration/deceleration on vehicles near both ends of the vehicle.

In the vehicle group control method of the invention, when the vehicle speed of the vehicle group before the changing of the inter-vehicle distance is zero, all target inter-vehicle distances of the vehicle group may be fixed within a predetermined time after the start of changing the inter-vehicle distance, and when the vehicle speed of the vehicle group after the inter-vehicle distance has been changed is set to zero, all target inter-vehicle distances of the vehicle group are fixed within a predetermined time before the end of changing the inter-vehicle distance.

When a vehicle is started in the stopping state of the vehicle group to extend the inter-vehicle distance, in a predetermined time from the start, it is difficult to control acceleration/deceleration with high accuracy. When the inter-vehicle distance is reduced in the traveling state of the vehicle group to stop a vehicle, it is difficult to control acceleration/deceleration with high accuracy in a predetermined time before stopping. If complex control of the inter-vehicle distance is performed in a time slot when it is difficult to control acceleration/deceleration, the timing of simultaneous starting or stopping of the respective vehicles may be confused. In contrast, with the above-described vehicle group control method, all the target inter-vehicle distances are fixed in a time slot when it is difficult to control acceleration/deceleration with high accuracy, making it comparatively easy to control the inter-vehicle distance and suppressing confusion of the timing of simultaneous starting or stopping.

In the vehicle group control method of the invention, when the vehicle speed of the vehicle group is lower than a predetermined value, all target inter-vehicle distances of the vehicle group may be fixed.

From the viewpoint of the natures of the vehicles, when the vehicle speed is low, it is difficult to control acceleration/deceleration with high accuracy. For this reason, if complex control of the inter-vehicle distance is performed, the inter-vehicle distance of the vehicle group may be confused. In contrast, with the above-described vehicle group control method, when the vehicle speed of the vehicle group is lower than a predetermined value, all the target inter-vehicle distances are fixed. Thus, for example, when the vehicle speed is low immediately after starting or immediately before stopping, it is possible to suppress confusion of the inter-vehicle distance.

In the vehicle group control method of the invention, in changing all the inter-vehicle distances within the vehicle group, the changing of the inter-vehicle distance between a k-th vehicle from the front and a (k+1)th vehicle (where k=2, 3, . . . , n−1) within the vehicle group may start immediately after changing the inter-vehicle distance between a (k−1)th vehicle from the front and the k-th vehicle within the vehicle group has been completed.

With this vehicle group control method, in changing the inter-vehicle distance within the vehicle group, changing the inter-vehicle distance is completed sequentially from the front to the rear of the vehicle group. Thus, when there are a large number of vehicles forming a vehicle group, there is no case where great acceleration/deceleration is necessary in a vehicle near the tail of the vehicle group, reducing a burden of acceleration/deceleration on the vehicles.

In the vehicle group control method of the invention, in changing the inter-vehicle distance within the vehicle group, the relative speed of each vehicle may be changed such that the timing when the relative speed reaches a peak becomes slower in a vehicle at the rear of the vehicle group.

With this vehicle group control method, in changing the inter-vehicle distance within the vehicle group, the relative speed with respect to a vehicle before the host vehicle reaches a peak sequentially from a vehicle at the front of the vehicle group. Thus, the vehicle moves within the vehicle group such that the inter-vehicle distance is changed sequentially from the front to the rear of the vehicle group. Thus, even when there are a large number of vehicles forming a vehicle group, there is no case where great acceleration/deceleration is necessary in a vehicle near the tail of the vehicle group, reducing a burden of acceleration/deceleration on the vehicles.

In the vehicle group control method of the invention, in extending all the inter-vehicle distances within the vehicle group, for all succeeding vehicles other than the leading vehicle of the vehicle group, after deceleration has been started simultaneously with respect to the leading vehicle, the succeeding vehicles may be switched to acceleration at respective switching timings and accelerated until the vehicle speed becomes equal to the vehicle speed of the leading vehicle, and the switching timing becomes slower in a vehicle at the rear of the vehicle group.

With this vehicle group control method, deceleration is started simultaneously in the succeeding vehicles with respect to the leading vehicle, and the succeeding vehicles are accelerated sequentially from a succeeding vehicle at the front and return to a vehicle speed which is equal to the leading vehicle. Deceleration is initially started simultaneously in the succeeding vehicles. For this reason, it is possible to simultaneously change all the inter-vehicle distances to some extent, and it becomes possible to comparatively rapidly change the inter-vehicle distance. While the relative movement distance with respect to the leading vehicle more increases in a vehicle at the rear, the switching timing is slower in a vehicle at the rear. Therefore, the movement time is extended, and there is no case where great acceleration/deceleration is forced in a succeeding vehicle.

In the vehicle group control method of the invention, in reducing all the inter-vehicle distances within the vehicle group, for all succeeding vehicles other than the leading vehicle of the vehicle group, after acceleration has been started simultaneously with respect to the leading vehicle, the succeeding vehicles may be switched to deceleration at respective switching timings and decelerated until the vehicle speed becomes equal to the vehicle speed of the leading vehicle, and the switching timing becomes slower in a vehicle at the rear of the vehicle group.

With this vehicle group control method, for the succeeding vehicles, acceleration is started simultaneously with respect to the leading vehicle, and the succeeding vehicles are decelerated sequentially from the succeeding vehicle at the front and return to a vehicle speed which is equal to the leading vehicle. Acceleration is initially started simultaneously in the succeeding vehicles. For this reason, it is possible to simultaneously change all the inter-vehicle distances to some extent, and it becomes possible to comparatively rapidly change the inter-vehicle distance. While the relative movement distance with respect to the leading vehicle more increases in a vehicle at the rear, the switching timing is slower in a vehicle at the rear. Therefore, the movement time is extended, and there is no case where great acceleration/deceleration is forced in the succeeding vehicles.

A vehicle of the invention includes vehicle group control means for controlling traveling of a vehicle group having n vehicles (where n=2, 3, . . . ). In extending the inter-vehicle distance between a (j−1)th vehicle from the front and a j-th vehicle (where j=2, 3, . . . , n) within the vehicle group, the vehicle control means changes the relative speed of the j-th vehicle with respect to the (j−1)th vehicle during the changing of the inter-vehicle distance as indicated by a graph with a minimum value on a time axis.

With this vehicle, in extending the inter-vehicle distance between the (j−1)th vehicle and the j-th vehicle of the vehicle group, the relative speed of the j-th vehicle with respect to the (j−1)th vehicle is changed smoothly as indicated by a graph with a minimum value on a time axis. Therefore, it is possible to accurately extend the inter-vehicle distance with a smooth variation in the relative speed.

A vehicle of the invention includes vehicle group control means for controlling traveling of a vehicle group having n vehicles (where n=2, 3, . . . ). In reducing the inter-vehicle distance between a (j−1)th vehicle from the front and a j-th vehicle (where j=2, 3, . . . , n) within the vehicle group, the vehicle group control means changes the relative speed of the j-th vehicle with respect to the (j−1)th vehicle during the changing of the inter-vehicle distance as indicated by a graph with a maximum value on a time axis.

With this vehicle, in reducing the inter-vehicle distance between the (j−1)th vehicle and the j-th vehicle of the vehicle group, the relative speed of the j-th vehicle with respect to the (j−1)th vehicle is changed smoothly as indicated by a graph with a maximum value on a time axis. Therefore, it is possible to accurately reduce the inter-vehicle distance with a smooth variation in the relative speed.

### Advantageous Effects of Invention

According to the vehicle group control method and the vehicle of the invention, it is possible to change the inter-vehicle distance accurately with a smooth variation in a relative vehicle speed at the time of vehicle group traveling.

### BRIEF DESCRIPTION OF DRAWINGS

FIG. 1 is a block diagram showing first to sixth embodiments of a vehicle group traveling control system in a vehicle according to the invention.

FIG. 2 is a diagram showing vehicle group traveling which is realized by the vehicle group traveling control system of FIG. 1.

FIG. 3 is a flowchart showing processing for changing an inter-vehicle distance at the time of vehicle group traveling.

FIG. 4(a) is a graph showing a target value variation pattern of a relative acceleration in the first embodiment, FIG. 4(b) is a graph showing a target value variation pattern of a relative speed, and FIG. 4(c) is a graph showing a target value variation pattern of a variation in a front inter-vehicle distance.

FIG. 5 is a graph showing an example of variations of vehicle speeds V₁ to V₄ in an inter-vehicle distance changing step.

FIG. 6(a) is a graph showing a target value variation pattern of a relative acceleration in the first embodiment, FIG. 6(b) is a graph showing a target value variation pattern of a relative speed, and FIG. 6(c) is a graph showing a target value variation pattern of a variation in a front inter-vehicle distance.

FIG. 7(a) is a graph showing an example of variations in vehicle speeds V₁ to V₄ in an inter-vehicle distance changing step, and FIG. 7(b) is a graph showing an example of variations in vehicle speeds V₁ to V₄ in an inter-vehicle distance changing step of the second embodiment.

FIG. 8 is a diagram showing a reference position Z which is set at the position of a vehicle C₂.

FIG. 9 is a graph showing an example of variations in vehicle speeds V₁ to V₄ in an inter-vehicle distance changing step of the third embodiment.

FIG. 10 is a graph showing another example of variations in vehicle speeds V₁ to V₄ in an inter-vehicle distance changing step of the third embodiment.

FIG. 11 is a graph showing an example of variations in vehicle speeds V₁ to V₄ in an inter-vehicle distance changing step of the fourth embodiment.

FIG. 12 is a graph showing another example of variations in vehicle speeds V₁ to V₄ in an inter-vehicle distance changing step of the fourth embodiment.

FIGS. 13(a) to (d) are graphs showing an example of variations in vehicle speeds V₁ to V₄ in an inter-vehicle distance changing step of the fifth embodiment.

FIG. 14(a) is a graph showing a target value variation pattern of a relative speed in the fifth embodiment, and FIG. 14(b) is a graph showing a target value variation pattern of a variation in a front inter-vehicle distance.

FIG. 15 is a graph showing another example of variations in vehicle speeds V₁ to V₄ in an inter-vehicle distance changing step of the sixth embodiment.

FIG. 16(a) is a graph showing a target value variation pattern of a relative speed in the sixth embodiment, and FIG. 16(b) is a graph showing a target value variation pattern of a variation in a front inter-vehicle distance.

### DESCRIPTION OF EMBODIMENTS

Hereinafter, preferred embodiments of a vehicle and a vehicle group control method according to the invention will be described in detail with reference to the drawings. In the following embodiments, overlapping description of the same parts or equivalent parts will be omitted.

### First Embodiment

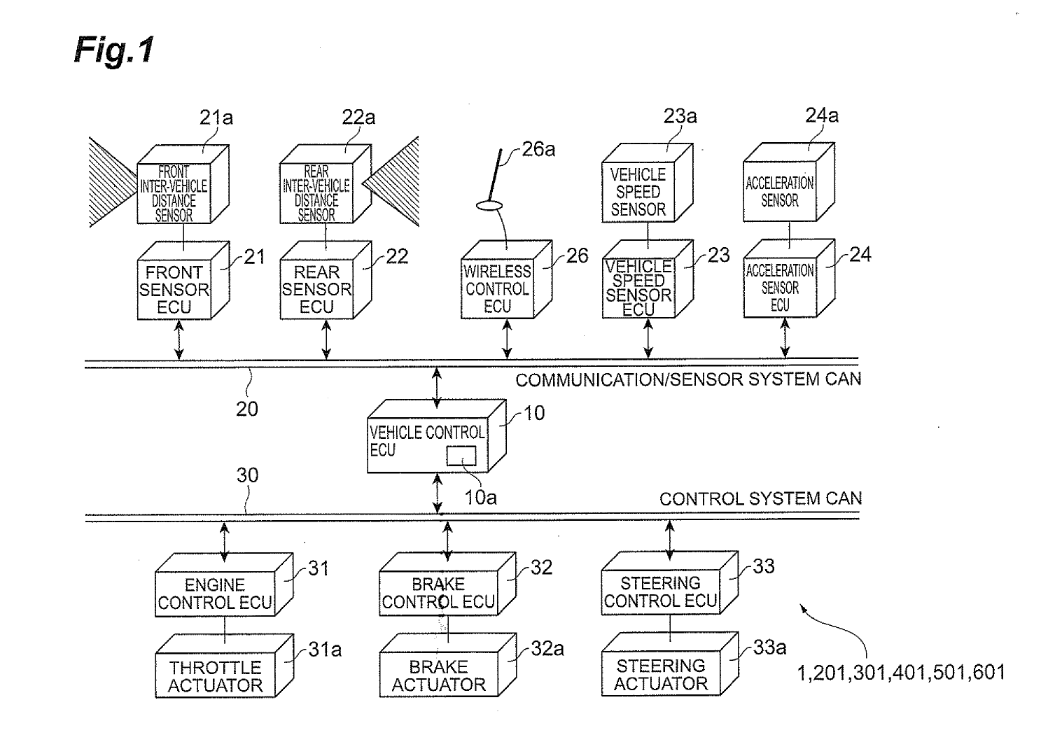

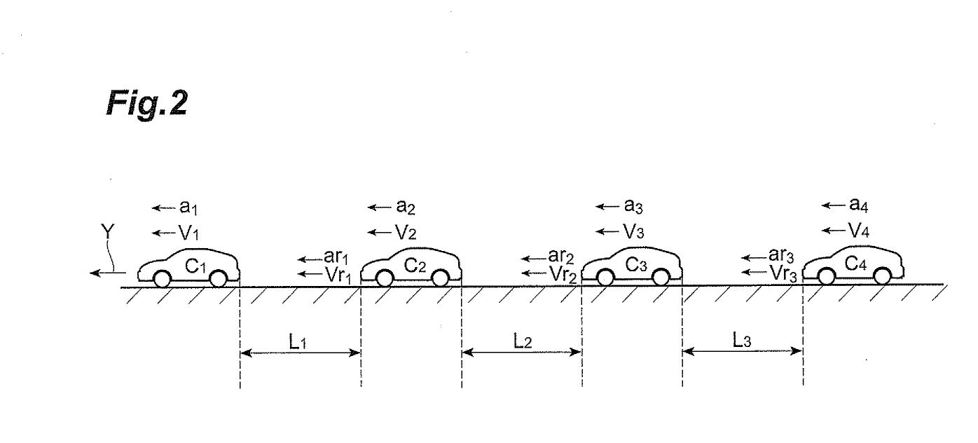

A vehicle group traveling control system 1 shown in FIG. 1 is a system which controls the traveling states of a plurality of vehicles to cause a plurality of vehicles to travel in the form of a vehicle group. With the vehicle group traveling control system 1, as shown in FIG. 2, vehicle group traveling is realized in which a plurality of vehicles are arranged in a column at a comparatively small inter-vehicle distance.

In the following description, the number of vehicles forming a vehicle group is denoted by “n”. In the example of FIG. 2, the number of vehicles is n=4. As shown in FIG. 2, the acceleration of a j-th (where j=1, 2, n) vehicle Cⱼ from the head of the vehicle group is denoted by “aⱼ”, the speed of the vehicle Cⱼ is denoted by “Vⱼ”, and the acceleration command value of the vehicle Cⱼ is denoted by “uⱼ”. The inter-vehicle distance between the vehicle Cⱼ and a vehicle Cⱼ₊₁ is denoted by “Lⱼ”. The relative speed Vⱼ₊₁−Vⱼ of the vehicle Cⱼ₊₁ with respect to the vehicle Cⱼ is denoted by “Vrⱼ”, and the relative acceleration aⱼ₊₁-aₐ of the vehicle Cⱼ₊₁ with respect to the vehicle Cⱼ is denoted by “arⱼ”. With regard to the speed Vⱼ, the relative speed Vrⱼ, the acceleration aⱼ, and the relative acceleration arⱼ, the traveling method (the direction indicated by the arrow Y) of the vehicle group has a plus sign. Of the vehicles C₁ to Cₙ forming the vehicle group, the vehicle C₁ which is traveling at the head may be called “leading vehicle”, and the vehicles C₂ to Cₙ may be collectively “succeeding vehicles”. The vehicle Cₙ may be called “trailing vehicle”.

Although in this vehicle group traveling control system 1, traveling of a vehicle group having an arbitrary number of vehicles can be realized, as shown in FIG. 2, an example will be described where traveling of a vehicle group having four vehicles C₁, C₂, C₃, and C₄ is carried out (when n=4).

The vehicle group traveling control system 1 described below is mounted in each of all the vehicles C₁ to C₄ forming the vehicle group.

As shown in FIG. 1, the vehicle group traveling control system 1 includes a vehicle control ECU (Electronic Control Unit) 10. The vehicle control ECU 10 is an electronic control unit which performs overall control of the vehicle group traveling control system 1 and mainly includes a computer having a CPU, a ROM, and a RAM. The vehicle control ECU 10 has an information storage section 10a which stores information temporarily or for a long term. The information storage section 10a stores vehicle specification information representing various characteristics of the host vehicle. The vehicle control ECU 10 functions as arithmetic means for calculating the acceleration command values u₁ to u₄ of the vehicles C₁ to C₄ through a predetermined arithmetic operation described below.

The vehicle group traveling control system 1 also includes sensors for detecting the traveling state of the host vehicle. The sensors include a front inter-vehicle distance sensor 21a, a rear inter-vehicle distance sensor 22a, a vehicle speed sensor 23a, and an acceleration sensor 24a.

The front inter-vehicle distance sensor 21a can detect the inter-vehicle distance from a vehicle which is traveling immediately before the host vehicle. Similarly, the rear inter-vehicle distance sensor 22a can detect the inter-vehicle distance from a vehicle which is traveling immediately behind the host vehicle. As the front inter-vehicle distance sensor 21a and the rear inter-vehicle distance sensor 22a, for example, millimeter-wave radars are used which are respectively provided at the front and rear parts of the vehicle. A signal obtained by the front inter-vehicle distance sensor 21a is processed by a front sensor ECU 21 and transmitted to the vehicle control ECU 10 as front inter-vehicle distance information. Similarly, a signal obtained by the rear inter-vehicle distance sensor 22a is processed by a rear sensor ECU 22 and transmitted to the vehicle control ECU 10 as rear inter-vehicle distance information.

The vehicle speed sensor 23a can detect the vehicle speed of the host vehicle. As the vehicle speed sensor 23a, for example, an electromagnetic pickup sensor is used which detects the wheel speed. A signal obtained by the vehicle speed sensor 23a is processed by the vehicle speed sensor ECU 23 and transmitted to the vehicle control ECU 10 as vehicle speed information. As the acceleration sensor 24a, for example, a gas rate sensor or a gyro sensor is used. A signal obtained by the acceleration sensor 24a is processed by the acceleration sensor ECU 24 and transmitted to the vehicle control ECU 10 as acceleration information.

The front sensor ECU 21, the rear sensor ECU 22, the vehicle speed sensor ECU 23, and the acceleration sensor ECU 24 are connected to the vehicle control ECU 10 through a communication/sensor system CAN 20 which is constructed as an in-vehicle network.

As described above, in the vehicle group traveling control system 1, front inter-vehicle distance information, rear inter-vehicle distance information, vehicle speed information, and acceleration information for the host vehicle are obtained by the above-described sensors. In the following description, front inter-vehicle distance information, rear inter-vehicle distance information, vehicle speed information, and acceleration information may be collectively referred to as “traveling state information”.

The system 1 also includes an engine control ECU 31, a brake control ECU 32, and a steering control ECU 33 for manipulating acceleration/deceleration, steering, and the like of the host vehicle. The engine control ECU 31 receives acceleration command value information transmitted from the vehicle control ECU 10 and manipulates a throttle actuator 31a and the like with an amount of manipulation corresponding to the acceleration command value. The brake control ECU 32 receives the acceleration command value information and manipulates a brake actuator 32a and the like with an amount of manipulation corresponding to the acceleration command value. The steering control ECU 33 receives steering command value information transmitted from the vehicle control ECU 10 and manipulates a steering actuator 33a and the like with an amount of manipulation corresponding to the steering command value. The engine control ECU 31, the brake control ECU 32, and the steering control ECU 33 are connected to the vehicle control ECU 10 through a control system CAN 30 which is constructed as an in-vehicle network.

The vehicle group traveling control system 1 also includes a wireless antenna 26a and a wireless control ECU 26 for exchanging traveling state information and the like with other vehicles in the vehicle group. The vehicles C₁ to C₄ in the vehicle group perform vehicle-to-vehicle communication with each other through the wireless antenna 26a and the wireless control ECU 26 to acquire the vehicle specification information, the traveling state information, and the acceleration command value information of all other vehicles and to transmit the vehicle specification information, the traveling state information, and the acceleration command value information of the host vehicle to other vehicles. Through such vehicle-to-vehicle communication, in the vehicle control ECUs 10 of all the vehicles C₁ to C₄ can share the vehicle specification information, the traveling state information, and the acceleration command value information of all the vehicles C₁ to C₄. The vehicles C₁ to C₄ may share various other kinds of information through vehicle-to-vehicle communication, in addition to the traveling state information and the like. The wireless control ECU is connected to the vehicle control ECU 10 through the above-described communication/sensor system CAN 20.

The vehicle group traveling control system 1 controls the traveling state of each of the vehicles C₁ to C₄ on the basis of a set inter-vehicle distance L from an upper-level application or a driver such that all the inter-vehicle distances L₁ to L₃ within the vehicle group are maintained equal to the set inter-vehicle distance L. The vehicle group traveling control system 1 of the leading vehicle C₁ controls acceleration/deceleration of the host vehicle C₁ on the basis of a feedforward acceleration command value u_{ff} from an upper-level application or a driver. The vehicle group traveling control system 1 of each succeeding vehicle Cₘ (where m=2, 3, 4) controls acceleration/deceleration of the host vehicle Cₘ such that the front inter-vehicle distance Lₘ₋₁ of the host vehicle Cₘ is maintained at the target inter-vehicle distance L with the set inter-vehicle distance L as the target inter-vehicle distance. In the acceleration/deceleration control, the front inter-vehicle distance Lₘ₋₁ of the host vehicle Cₘ, the relative speed Vrₘ₋₁ with respect to the preceding vehicle Cₘ₋₁, and the relative acceleration arₘ₋₁ with respect to the preceding vehicle Cₘ₋₁ are fed back.

The front inter-vehicle distance Lₘ₋₁ to be fed back is acquired from the front inter-vehicle distance sensor 21a. The relative speed Vrₘ₋₁ is acquired by calculating the difference between the vehicle speed Vₘ obtained by the vehicle speed sensor 23a and the vehicle speed Vₘ₋₁ of the preceding vehicle Cₘ₋₁ obtained through vehicle-to-vehicle communication. The relative acceleration arₘ₋₁ is acquired by calculating the difference between the acceleration aₘ obtained by the acceleration sensor 24a and the acceleration aₘ₋₁ of the preceding vehicle Cₘ₋₁ obtained through vehicle-to-vehicle communication. As described above, the vehicles C₂ to C₄ control the traveling states to maintain the front inter-vehicle distance, such that vehicle group traveling is realized in which the four vehicles C₁ to C₄ are traveling in a state of being arranged in a line at regular intervals of the set inter-vehicle distance L. The value of the set inter-vehicle distance L is temporarily stored in, for example, the information storage section 10a of the vehicle control ECU 10.

Subsequently, during vehicle group traveling, processing of the vehicle group traveling control system 1 when the set inter-vehicle distance L is changed will be described. Hereinafter, a step of changing the inter-vehicle distances L₁ to L₃ in accordance with a change in the set inter-vehicle distance L may be called “inter-vehicle distance changing step”.

[Processing for Extending Inter-Vehicle Distance]

Here, a variation Ls in the inter-vehicle distances L₁ to L₃ to be changed and a variation time ts necessary for changing the inter-vehicle distances L₁ to L₃ are given in accordance with a change in the set inter-vehicle distance L from an upper-level application or a driver. The given variation Ls and variation time ts are shared by all the vehicles C₁ to C₄ within the vehicle group through vehicle-to-vehicle communication. The vehicle group traveling control systems 1 of the vehicles C₁ to C₄ are in synchronization at the time of the start of the inter-vehicle distance changing step and separately start to control the host device in changing the front inter-vehicle distance.

The following description will be provided as to processing which is performed by the vehicle group traveling control system 1 of the m-th vehicle Cₘ (where m=2, 3, 4) from the head of the vehicle group. While the vehicle group traveling control system 1 of the vehicle Cₘ has to recognize the placing (the value of m: how many vehicles precede before the host vehicle within the vehicle group) of the host vehicle, the placing of the host vehicle can be derived by comparing the current positions of the vehicles C₁ to C₄ which are shared through vehicle-to-vehicle communication. In this case, each of the vehicles C₁ to C₄ may include host vehicle position detecting means, such as a GPS device, so as to acquire the current position of the host vehicle.

Here, a case where an instruction indicating extension of the inter-vehicle distance is given from an upper-level application or the like will be taken into consideration. That is, the given variation Ls has a plus value.

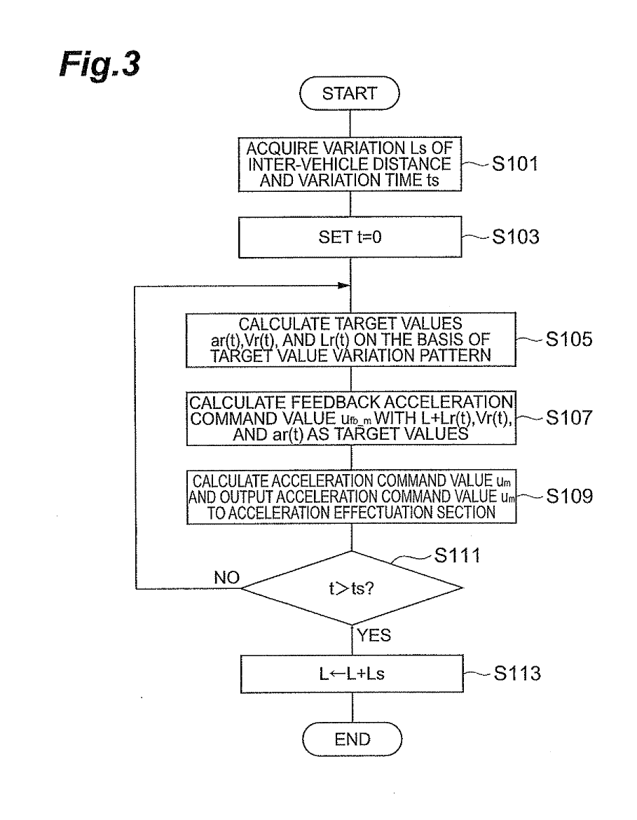

As shown in a flowchart of FIG. 3, first, the vehicle control ECU 10 of the vehicle group traveling control system 1 acquires the variation Ls of the front inter-vehicle distance Lₘ₋₁ and the variation time ts from an upper-level application or the like (S101). At this time, time t is set as t=0 (S103). Subsequently, the vehicle control ECU 10 calculates target values ar(t), Vr(t), and Lr(t) corresponding to the current time t on the basis of target value variation patterns which are determined on the basis of the variation Ls and the variation time ts (S105).

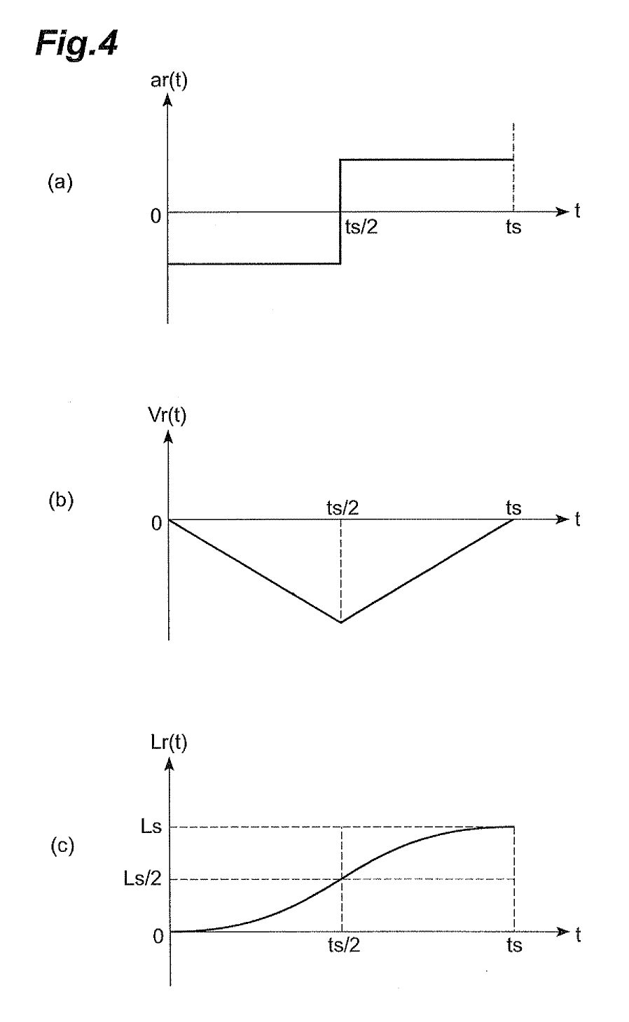

The target value variation patterns refer to time-dependent variation patterns concerning the target value of a variation in the front inter-vehicle distance Lₘ₋₁, the target value of the relative speed Vrₘ₋, and the target value of the relative acceleration arₘ₋₁ at the time t=0 to ts, which are used for acceleration/deceleration control of the vehicle Cₘ. The target value variation patterns are set on the basis of the variation Ls and the variation time ts. Here, the relationship Ls/2=1/2·ar·(ts/2)² is established, and the target value Lr(t) of the variation in the front inter-vehicle distance Lₘ₋₁ at the time t is indicated by a curvilinear graph shown in FIG. 4(c). In this graph, a variation the front inter-vehicle distance Lₘ₋₁ is extended is indicated by a plus sign, and a variation in which the inter-vehicle distance Lₘ₋₁ is reduced is indicated by a minus sign. The target value Vr(t) of the relative speed Vrₘ₋₁ at the time t is obtained by temporally differentiating the target value Lr(t) and, as shown in FIG. 4(b), indicated by a V-shaped graph which has two lines in a downward convex shape. The graph of the target value Vr(t) has a minimum value at t=ts/2.

That is, the target value Vr(t) is expressed as follows.

Vr(t)=−(4Ls/ts²)·t (0≦t≦ts/2) (1.1)

Vr(t)=−(4Ls/ts²)·(ts−t) (ts/2<t≦ts) (1.2)

The target value ar(t) of the relative acceleration arₘ₋₁ at the time t is obtained by temporally differentiating the target value Vr(t). As shown in FIG. 4(a), the target value ar(t) has a minus constant value in the first half (0<t≦ts/2) of the inter-vehicle distance changing step and has a plus constant value in the second half (ts/2<t≦ts).

The vehicle Cₘ changes the front inter-vehicle distance Lₘ₋₁, the relative speed Vrₘ₋₁, and the relative acceleration arₘ₋₁ at the time t=0 to ts in accordance with the target value variation patterns shown in FIGS. 4(a), (b), and (c) through acceleration/deceleration control described below. With these target value variation patterns, in the first half (0<t≦ts/2) of the inter-vehicle distance changing step, the vehicle Cₘ is relatively decelerated at a constant deceleration with respect to the preceding vehicle Cₘ₋₁, and in the second half (ts/2<t≦ts) of the inter-vehicle distance changing step, the vehicle Cₘ is relatively accelerated at a constant acceleration with respect to the preceding vehicle Cₘ₋₁. In the vehicle group traveling control system 1, the target value variation patterns shown in FIGS. 4(a), (b), and (c) are used in common for all the vehicles C₁ to C₄.

Subsequently, the vehicle control ECU 10 calculates a feedback acceleration command value u_{fb}_{_{—}}ₘ at the time t with L+Lr(t), Vr(t), and ar(t) as a target front inter-vehicle distance Lₘ₋₁_{_{—}}_{tgt}, a target relative speed Vrₘ₋_{_{—}}_{tgt}, and a target relative acceleration arₘ₋₁_{_{—}}_{tgt} (S107).

Specifically, the feedback acceleration command value u_{fb}_{_{—}}ₘ is calculated by Expression (1.3).

u_{fb}_{_{—}}ₘ=k·(Lₘ₋₁−Lₘ₋₁_{_{—}}_{tgt})+c·(Vrₘ₋₁−Vrₘ₋₁_{_{—}}_{tgt})+f·(arₘ₋₁−arₘ₋₁_{_{—}}_{tgt}) (1.3)

In Expression (1.3), k, c, and f are predefined gains and stored in, for example, the information storage section 10a of the vehicle control ECU 10. In Expression (1.3), even when c=0 and f=0, feedback control of the front inter-vehicle distance Lₘ₋₁ is possible. Meanwhile, the relationships c≠0 and f≠0 are satisfied, such that the relative speed Vrₘ₋₁ and the relative acceleration arₘ₋₁ are changed in accordance with the target values Vr(t) and ar(t), respectively.

Next, the vehicle control ECU 10 feeds forward the feedforward acceleration command value u_{ff} of the leading vehicle C₁ and calculates the acceleration command value uₘ of the host vehicle Cₘ. Specifically, the acceleration command value uₘ is calculated by Expression (1.4).

uₘ=u_{ff}+u_{fb}_{_{—}}ₘ−ar(t)·(m−1) (1.4)

The vehicle control ECU 10 transmits the calculated acceleration command value uₘ to the engine control ECU 31 and the brake control ECU 32 serving as an acceleration effectuation section (S109). At this time, the engine control ECU 31 manipulates the throttle actuator 31a on the basis of the received acceleration command value uₘ, and the brake control ECU 32 manipulates the brake actuator 32a on the basis of the received acceleration command value uₘ. Thus, acceleration/deceleration of the vehicle Cₘ is effectuated. Here, instead of Expression (1.4), Expression (1.5) may be used.

uₘ=u_{ff}′+u_{fb}_{_{—}}ₘ−ar(t) (1.5)

In Expression (1.5), u_{ff}′ represents a feedforward acceleration command value of the vehicle Cₘ₋₁ immediately before the host vehicle.

S105 to S109 are repeated until the condition t>ts is satisfied (S111), such that the front inter-vehicle distance Lₘ₋₁ of the vehicle Cₘ increases by a distance Ls at the time t=0 to ts. Thereafter, the set inter-vehicle distance L is updated to a new distance L+Ls (S113). S101 to S113 are performed by each of the vehicles C₂ to C₄, it is effectuated that all the inter-vehicle distances L₁ to L₃ within the vehicle group are extended by the distance Ls at the same timing for the time ts.

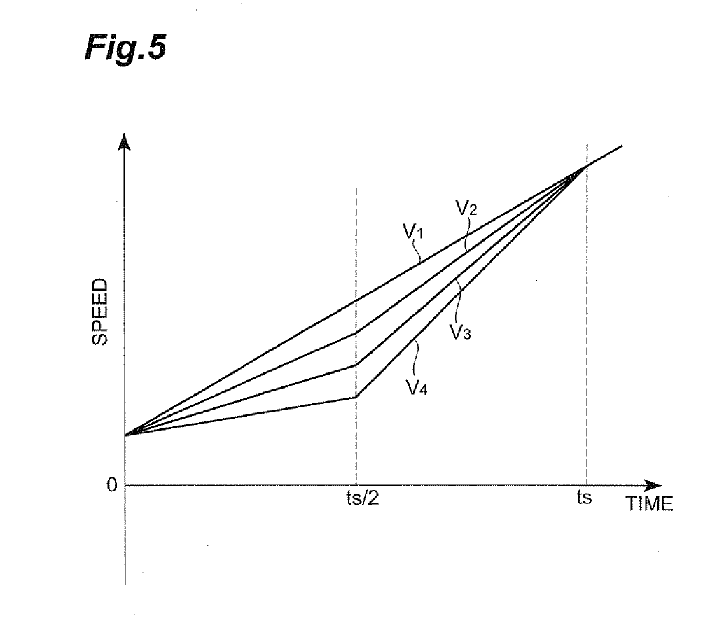

If, during the above-described inter-vehicle distance changing step, th leading vehicle C₁ is traveling at a constant acceleration on the basis of the acceleration command value u_{ff}, variations in the vehicle speeds V₁ to V₄ of the vehicle C₁ to C₄ at the time t=0 to ts are as shown in FIG. 5.

According to the vehicles C₁ to C₄ each having the vehicle group traveling control system 1 and the vehicle group traveling control method described above, in changing the inter-vehicle distances L₁ to L₃, the target value variation patterns at the inter-vehicle distance variation time t=0 to is are given to the front inter-vehicle distance, the relative speed, and the relative acceleration, and the front inter-vehicle distances L₁ to L₃, the relative speeds Vr₁ to Vr₃, and the relative acceleration ar₁ to ar₃ are changed with time-dependent variations based on the target value variation patterns. As shown in FIG. 4(b), the target value Vr(t) of the relative speed of each vehicle Cₘ with respect to the preceding vehicle Cₘ₋₁ is indicated by a graph with a minimum value, such as the V-shaped graph having a downward convex shape (see FIG. 4(b)). Thus, the inter-vehicle distances Lₘ₋₁ are smoothly changed such that the vehicle Cₘ moves so as to be gradually separated from the preceding vehicle Cₘ₋₁ immediately after the start of the inter-vehicle distance changing step (around t=0), moves so as to be quickly separated from the preceding vehicle Cₘ₋₁ during the inter-vehicle distance changing step (around t=ts/2), and gradually stops with respect to the preceding vehicle Cₘ₋₁ immediately before the end of the inter-vehicle distance changing step (around t=ts). As described above, according to the vehicles C₁ to C₄ and the vehicle group traveling control method described above, it is possible to accurately change the inter-vehicle distances with smooth variations in the relative vehicle speed between the vehicles C₁ to C₄.

Here, the graph of the target value Vr(t) of the relative speed is the V-shaped graph, but the invention is not limited thereto. It should suffice that the graph of the target value Vr(t) is a graph with a minimum value on the t axis, and it is not necessary that the graph is linear. That is, it should suffice that, when t=0 and t=ts, Vr(t) is zero and, at t=0 to ts, the relationship Vr(t)≦0 is established. With this configuration, the target value Vr(t) of the relative speed is constantly equal to or smaller than zero at t=0 to ts. Thus, the inter-vehicle distances Lₘ₋₁ constantly continue to be extended at t=0 to ts, suppressing occurrence of unnecessary expansion and contraction of the inter-vehicle distances Lₘ₋₁.

[Processing for Reducing Inter-Vehicle Distance]

Subsequently, a case where an instruction indicating reduction of the inter-vehicle distance by Ls is given from an upper-level application or the like will be taken into consideration.

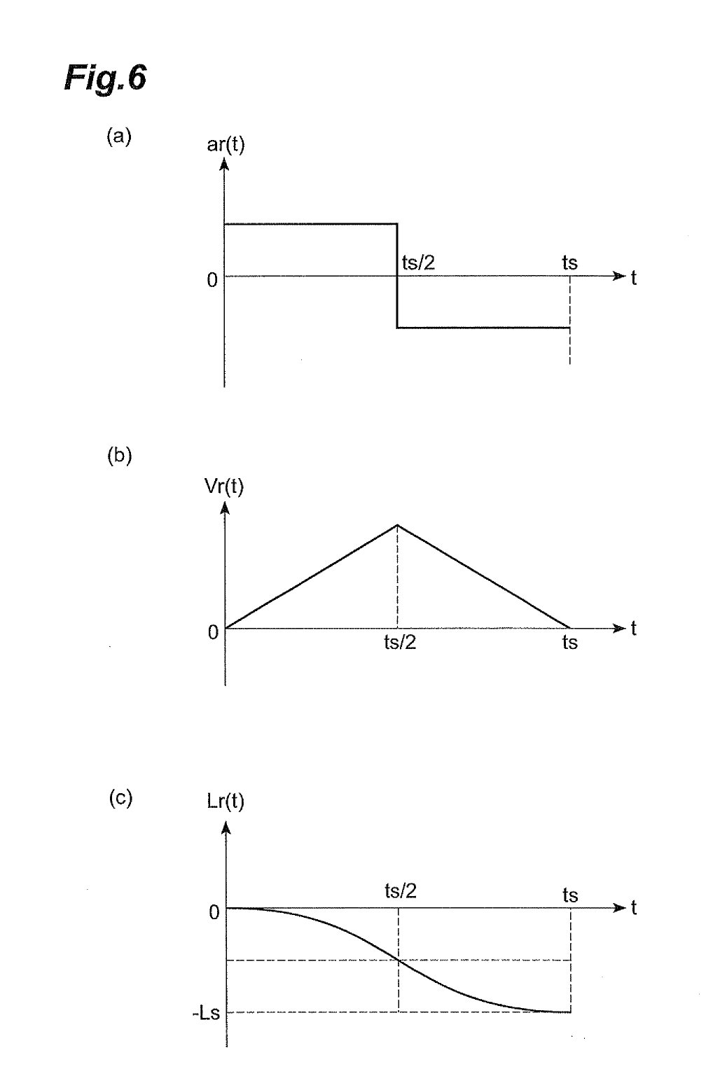

In this case, it should suffice that the variation in the inter-vehicle distance described above is −Ls, and the sign of the variation Ls described above is inverted. Thus, the target value variation patterns are obtained by vertically inverting the graphs of FIGS. 4(a) to (c) with respect to the time axis. That is, as shown in FIG. 6(c), the target value Lr(t) of the variation in the front inter-vehicle distance Lₘ₋₁ at the time t is indicated by a curvilinear graph which is obtained by vertically inverting the graph of FIG. 4(c). As shown in FIG. 6(b), the target value Vr(t) of the relative speed Vrₘ₋₁ at the time t is indicated by a chevron graph which is obtained by vertically inverting the graph of FIG. 4(b) and has two lines in an upward convex shape. The graph of the target value Vr(t) has a maximum value at t=ts/2.

That is, the target value Vr(t) is expressed as follows.

Vr(t)=(4Ls/ts²)·t (0<t≦ts/2) (1.6)

Vr(t)=(4Ls/ts²)·(ts−t) (ts/2<t≦ts) (1.7)

As shown in FIG. 6(a), the target value ar(t) of the relative acceleration arₘ₋₁ at the time t is indicated by a graph which is obtained by vertically inverting the graph of FIG. 4(a). The target value ar(t) has a plus constant value in the first half of the inter-vehicle distance changing step and has a minus constant value in the second half.

That is, with these patterns, in the first half (0<t≦ts/2) of the inter-vehicle distance changing step, the vehicle Cₘ is relatively accelerated at a constant acceleration with respect to the preceding vehicle Cₘ₋₁, and in the second half (ts/2<t≦ts) of the inter-vehicle distance changing step, the vehicle Cₘ is relatively decelerated at a constant deceleration with respect to the preceding vehicle Cₘ₋₁.

As described above, the target value Vr(t) of the relative speed of each vehicle Cₘ with respect to the preceding vehicle Cₘ₋₁ is indicated by a graph with a maximum value, such as the chevron graph having an upward convex shape (see FIG. 6(b)). Thus, the inter-vehicle distances Lₘ₋₁ are smoothly changed such that the vehicle Cₘ moves so as to be gradually close to the preceding vehicle Cₘ₋₁ immediately after the start of the inter-vehicle distance changing step (around t=0), moves so as to be quickly close to the preceding vehicle Cₘ₋₁ during the inter-vehicle distance changing step (around t=ts/2), and gradually stops with respect to the preceding vehicle Cₘ₋₁ immediately before the end of the inter-vehicle distance changing step (around t=ts). As described above, according to the vehicle group traveling control system 1 and the vehicle group traveling control method described above, even in reducing the inter-vehicle distances, it is possible to accurately change the inter-vehicle distances with smooth variations in the relative vehicle speed between the vehicles C₁ to C₄.

Here, the graph of the target value Vr(t) of the relative speed is the chevron graph, but the invention is not limited thereto. It should suffice that the graph of the target value Vr(t) is a graph with a maximum value on the t axis, and it is not necessary that the graph is linear. That is, it should suffice that, when t=0 and t=ts, Vr(t) is zero and, at t=0 to ts, the relationship Vr(t)≧0 is satisfied. With this configuration, the target value Vr(t) of the relative speed is constantly equal to or greater than zero at t=0 to ts. Therefore, the inter-vehicle distances constantly continue to be reduced at t=0 to ts, suppressing occurrence of unnecessary expansion and contraction of the inter-vehicle distances Lₘ₋₁.

### Second Embodiment

Subsequently, a second embodiment of the vehicle and the vehicle group control method according to the invention will be described. The physical configuration of a vehicle group traveling control system 201 mounted in each of the vehicles C₁ to C₄ of this embodiment is the same as the vehicle group traveling control system 1, as shown in FIG. 1, thus overlapping description will be omitted.

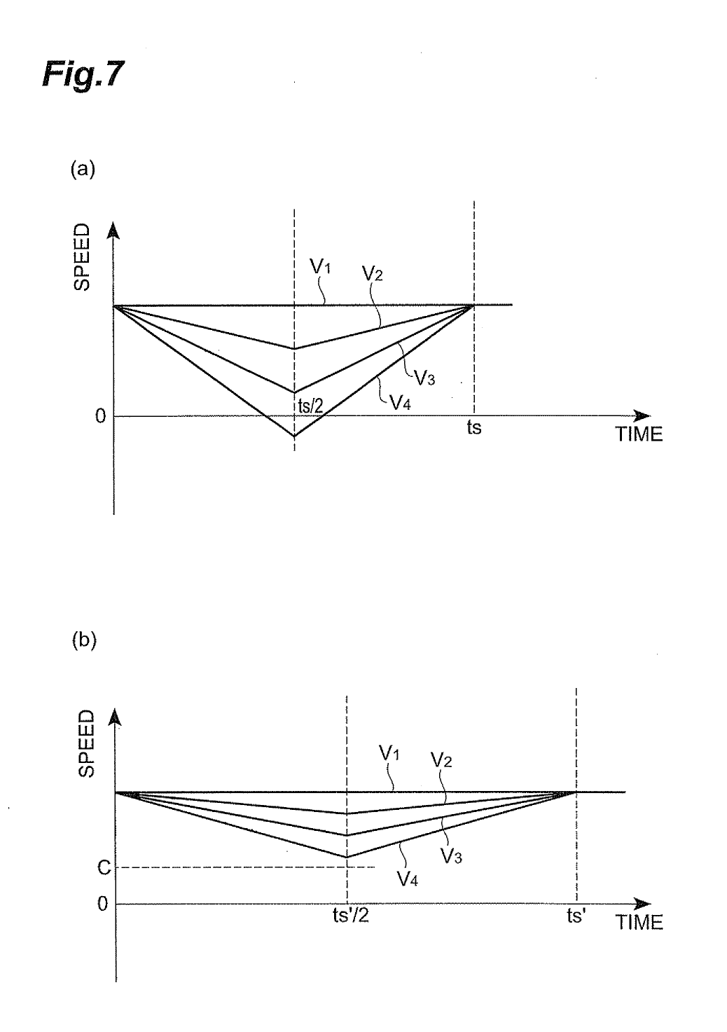

In the vehicle group traveling control system 1 and the vehicle group traveling control method described above, during the inter-vehicle distance changing step, as understood from Expression (1.4), a greater variation in speed is necessary in a vehicle at the rear of the vehicle group. Thus, if the leading vehicle C₁ is traveling at a constant speed based on the acceleration command value u_{ff}, variations in the vehicle speeds V₁ to V₄ of the vehicles C₁ to C₄ at the time t=0 to ts may be as shown in FIG. 7(a). In the example of FIG. 7(a), the vehicle speed V₄ of the vehicle C₄ has a minus value around the time t=ts/2. In this case, it is undesirable in that a retreat operation is necessary in the vehicle C₄ around the time t=ts/2 of the step of extending the inter-vehicle distance.

As shown in FIG. 7(a), a greater acceleration/deceleration is necessary in a vehicle at the rear of the vehicle group, increasing a burden of acceleration/deceleration on the succeeding vehicles. In this case, the succeeding vehicles are rapidly switched from deceleration to acceleration at the time t=ts/2, causing a problem from the viewpoint of ride quality. As described above, it is undesirable in that a heavy burden is forced on a vehicle near the tail of the vehicle group depending on the variation Ls and the variation time ts from an upper-level application or the like.

Thus, in the vehicle group traveling control system 201, when a heavy burden is imposed on the trailing vehicle Cₙ of the vehicle group depending on the given variation Ls and the variation time ts, the following processing is performed using a longer variation time ts′, instead of the given variation time ts. Specific processing is as follows. Here, it is assumed that, during the inter-vehicle distance changing step, the leading vehicle C₁ is traveling at a constant speed based on the acceleration command value u_{ff}.

First, if the variation Ls and the variation time ts are given, the vehicle control ECU 10 of the vehicle group traveling control system 201 calculates the minimum value of the vehicle speed Vₙ of the trailing vehicle Cₙ which is necessary during the inter-vehicle distance changing step. n is the number of vehicles forming the vehicle group. Specifically, the vehicle speed Vₙ has a minimum value at the time t=ts/2, such that the minimum value of the vehicle speed Vₙ is expressed by Expression (2.1).

Vₙ(minimum value)=V₁−(n−1)·4Ls/ts² (2.1)

As shown in FIG. 7(b), when the allowable condition is established such that the minimum value of the vehicle speed Vₙ is greater than a predetermined allowable speed c, the following expression is obtained.

V₁−(n−1)·4Ls/ts²>c (2.2)

The vehicle control ECU 10 calculates the acceleration/deceleration aₙ of the trailing vehicle Cₙ which is necessary during the inter-vehicle distance changing step. The acceleration/deceleration aₙ is expressed by Expression (2.3).

aₙ=|(n−1)·4Ls/ts²| (2.3)

If the allowable condition is established such that the acceleration/deceleration aₙ is lower than a predetermined allowable acceleration/deceleration aₜₕ, the following expression is obtained.

|(n−1)·4Ls/ts²|<aₜₕ (2.4)

The vehicle control ECU 10 calculates the minimum variation time ts′, which satisfies Expressions (2.2) and (2.4), on the basis of the number of vehicles n forming the vehicle group, the given variation Ls, and the vehicle speed V₁ of the leading vehicle C₁. When the calculated variation time ts′ is longer than the variation time ts from an upper-level application or the like, the vehicle control ECU 10 performs the following processing using the variation time ts′, instead of the variation time ts. The following processing is the same as S103 to S113 (see FIG. 3) in the vehicle group traveling control system 1, thus overlapping description will be omitted. Intrinsically, although the vehicle speeds V₁ to V₄ of the vehicles C₁ to C₄ shown in FIG. 7(a) which impose a heavy burden are necessary in accordance with an instruction from an upper-level application or the like, the vehicle speeds V₁ to V₄ shown in FIG. 7(b) are substituted, such that a burden imposed on a vehicle near the tail of the vehicle group is reduced.

According to the vehicle including the above-described vehicle group traveling control system 201 and the vehicle group traveling control method, during the inter-vehicle distance changing step, it is not necessary that the trailing vehicle Cₙ is decelerated to a low vehicle speed equal to or lower than an allowable speed c. It is not necessary that the vehicle Cₙ carries out great acceleration/deceleration equal to or higher than an allowable acceleration/deceleration aₜₕ. There is no case where rapid acceleration/deceleration switching occurs in the vehicle Cₙ around the time t=ts′/2. As a result, during the inter-vehicle distance changing step, it is possible to reduce a burden on the trailing vehicle Cₙ and a vehicle around the tail.

Although in this embodiment, the variation time ts′ is determined so as to satisfy the conditional expressions (2.2) and (2.4), the invention is not limited thereto. The variation time ts′ may be determined so as to satisfy any one of the conditional expressions (2.2) and (2.4).

### Third Embodiment

Subsequently, a third embodiment of the vehicle and the vehicle group control method according to the invention will be described. The physical configuration of a vehicle group traveling control system 301 mounted in each of the vehicles C₁ to C₄ of this embodiment is the same as the vehicle group traveling control system 1, as shown in FIG. 1, thus overlapping description will be omitted.

As described above, in the vehicle group traveling control system 1, during the inter-vehicle distance changing step, a heavy burden is likely to be more imposed on a vehicle at the rear of the vehicle group. Thus, in the vehicle group traveling control system 301, during the inter-vehicle distance changing step, a vehicle close to the leading vehicle C₁ and a vehicle close to the trailing vehicle C₄ are accelerated/decelerated in opposing directions.

[Processing for Extending Inter-Vehicle Distance]

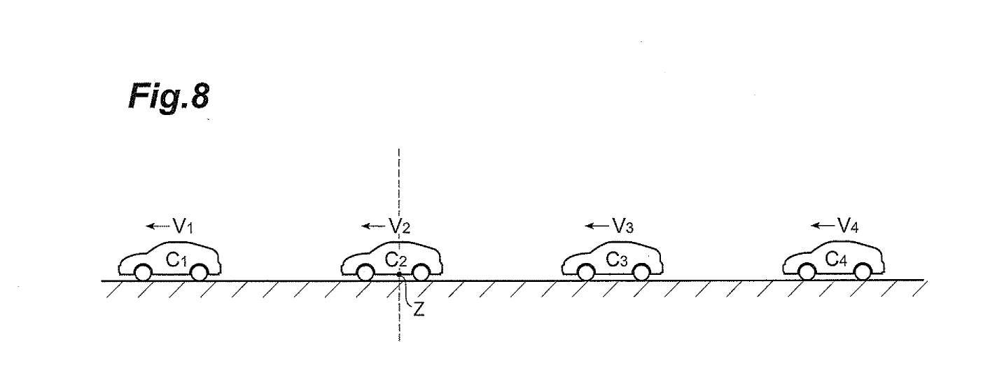

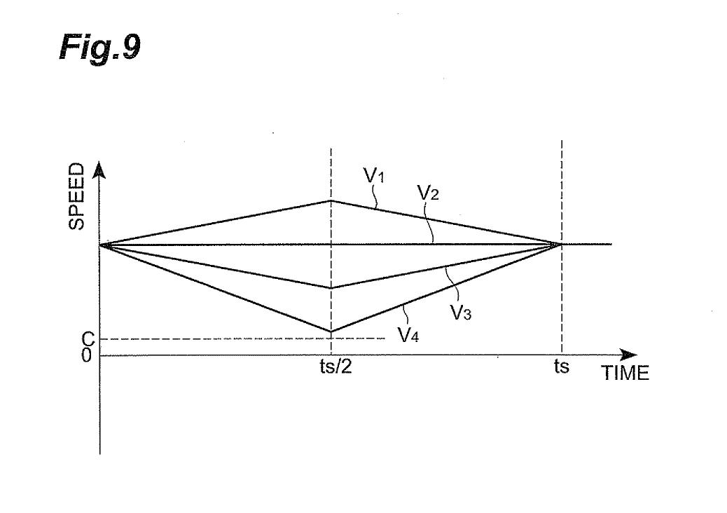

For example, in the step of extending the inter-vehicle distance, as shown in FIG. 8, in a reference position Z is set at the position of the vehicle C₂, as shown in FIG. 9, the vehicle speed V₁ of the vehicle C₁ before a reference position Z is indicated by a chevron graph which has two lines in an upward convex shape. The graph of the vehicle speed V₁ has a maximum value at t=ts/2. The vehicle speeds V₃ and V₄ of the succeeding vehicle C₃ and C₄ behind the reference position Z are indicated by a V-shaped graph in a downward convex shape. The graphs of the vehicle speeds V₃ and V₄ have a minimum value at t=ts/2. In this case, the vehicle C₂ is traveling at a constant speed during the inter-vehicle distance changing step.

In realizing the vehicle speeds V₁ to V₄ of the vehicles C₁ to C₄, the vehicle control ECU 10 of the vehicle Cₘ changes the acceleration command value u_{ff} of the leading vehicle C₁ to an acceleration command value u₁ of Expression (3.1) after the variation Ls and the variation time is have been given from an upper-level application or the like.

u₁=u_{ff}+k·ar(t) (3.1)

As shown in FIG. 6(a), ar(t) in Expression (3.1) is the value which represents the same time-dependent variation pattern as the target value ar(t) of the relative acceleration in the step of reducing the inter-vehicle distance. k in Expression (3.1) is appropriately determined in a range of 1<k<n−1 so as to satisfy Expression (2.2) described above. That is, k is determined such that the minimum value of the vehicle speed V₄ exceeds the allowable speed c.

The processing of the vehicle group traveling control system 301 in the subsequent vehicles Cₘ is the same as S103 to S113 in the vehicle group traveling control system 1 (see FIG. 3), thus overlapping description will be omitted.

The operations and effects of the vehicle including the vehicle group traveling control system 301 and the vehicle group traveling control method are as follows. The acceleration command value u₁ by Expression (3.1) is given to the leading vehicle C₁, such that, during the step of extending the inter-vehicle distance, the vehicle speed V₁ of the leading vehicle C₁ is indicated by a chevron graph which has two lines in an upward convex shape and has a maximum value (see FIG. 9). Accordingly, the graphs of the vehicle speeds V₂, V₃, and V₄ are also moved upward compared to the graph of FIG. 7(a). As a result, the minimum value of the vehicle speed V₄ can be comparatively increased, and the acceleration/deceleration of the vehicle C₄ can be suppressed comparatively low. Therefore, during the step of extending the inter-vehicle distance, it is possible to reduce a burden imposed on the trailing vehicle Cₙ and a vehicle around the tail without extending the variation time ts from an upper-level application or the like. That is, from the viewpoint that the variation time ts is prevented from being extended, the vehicle group traveling control system 301 is excellent compared to the vehicle group traveling control system 201.

Although in determining the value k in Expression (3.1), Expression (2.2) is a requisite condition, Expression (2.4) may be a requisite condition, or Expressions (2.2) and (2.4) may be a requisite condition. Although as shown in FIG. 8, the reference position Z is set at the position of the vehicle C₂, the reference position Z may be set at any position insofar as the position is between the leading vehicle C₁ and the trailing vehicle Cₙ of the vehicle group. For example, the reference position Z may be aligned with the position of any one of the vehicles C₁ to C₄, or may be set at a position between the vehicles without being aligned with the position of any one of the vehicles C₁ to C₄. The set position of the reference position Z may be shifted forth and back depending on the magnitude of the value k in Expression (3.1).

[Processing for Reducing Inter-Vehicle Distance]

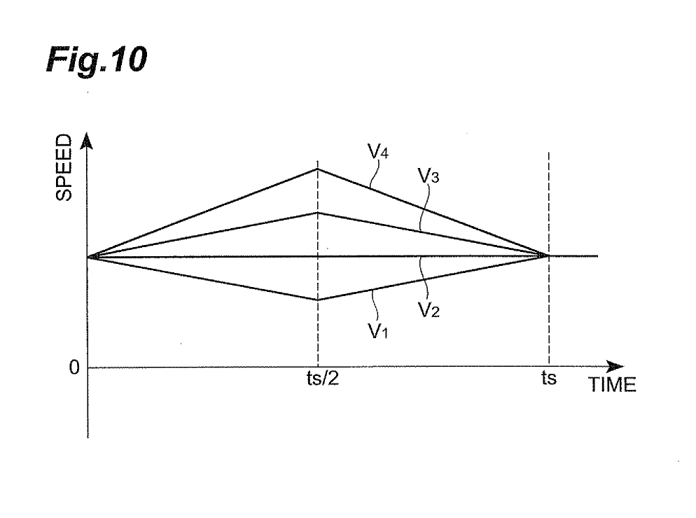

In the step of reducing the inter-vehicle distance, acceleration and deceleration of the vehicles C₁ to C₄ in the above-described step of extending the inter-vehicle distance may be reversed. In this case, as shown in FIG. 10, the vehicle speed V₁ of the vehicle C₁ before the reference position Z (see FIG. 8) is indicated by a V-shaped graph which has two lines in a downward convex shape. The graph of the vehicle speed V₁ has a minimum value at t=ts/2. The vehicle speeds V₃ and V₄ of the vehicles C₃ and C₄ behind the reference position Z are indicated by a chevron graph which has two lines in an upward convex shape. The graphs of the vehicle speeds V₃ and V₄ have a maximum value at t=ts/2. In this case, the vehicle C₂ is traveling at a constant speed during the inter-vehicle distance changing step.

As described above, in the step of reducing the inter-vehicle distance, the vehicle speed V₁ of the leading vehicle C₁ is indicated by a graph which has two lines in a downward convex shape and has a minimum value. Thus, the graphs of the vehicle speeds V₂, V₃, and V₄ are moved downward compared to the graph of FIG. 7(a). As a result, the maximum value of the vehicle speed V₄ can be comparatively reduced, and the acceleration/deceleration of the vehicle C₄ can be suppressed comparatively low. Therefore, during the step of reducing the inter-vehicle distance, it is possible to reduce a burden imposed on the trailing vehicle Cₙ and a vehicle around the tail without extending the variation time is from an upper-level application or the like.

### Fourth Embodiment

Subsequently, a fourth embodiment of the vehicle and the vehicle group control method according to the invention will be described. The physical configuration of a vehicle group traveling control system 401 mounted in each of the vehicles C₁ to C₄ of this embodiment is the same as the vehicle group traveling control system 1, as shown in FIG. 1, thus overlapping description will be omitted.

A case where the vehicles C₁ to C₄ start in the stopping state at a comparatively small inter-vehicle distance (in a state where the vehicle speed is zero) and are accelerated to extend the inter-vehicle distances, and a case where the vehicles C₁ to C₄ which are traveling in the form of the vehicle group are decelerated to reduce the inter-vehicle distances and are stopped at a comparatively small inter-vehicle distance (in a state where the vehicle speed is zero) are taken into consideration.

From the viewpoint of the natures of the vehicles, it is difficult to control an accurate inter-vehicle distance immediately after starting or immediately before stopping. For example, immediately after starting of the vehicle, the vehicle is creeping, making it difficult to perform acceleration/deceleration control with high accuracy. At a very low speed immediately before stopping of the vehicle, it is difficult to simultaneously stop the vehicles due to variations in the speed between the vehicles, or the like. If complex control of the inter-vehicle distance is performed immediately after starting or immediately before stopping, the timing of simultaneous starting or simultaneous stopping may be confused, causing confusion of the inter-vehicle distances of the vehicle group.

Thus, in the vehicle group traveling control system 401, for a predetermined time t1 immediately after starting and for a predetermined time t2 immediately before stopping, the inter-vehicle distances L₁ to L₃ are fixed. The time t1 and t2 is set in advance on the basis of a time zone when accurate acceleration/deceleration control of the vehicles C₁ to C₄ is easily performed and stored in advance in, for example, the information storage section 10a of the vehicle control ECU 10. For example, the time t1 and t2 are about several seconds.

[Processing Immediately after Starting]

Specifically, when the variation Ls in the inter-vehicle distance and the variation time ts are given from an upper-level application at the time of starting of the vehicle group, the vehicle control ECU 10 of the vehicle Cₘ changes the variation time ts to ts′ of Expression (4.1).

ts′=ts−t1 (4.1)

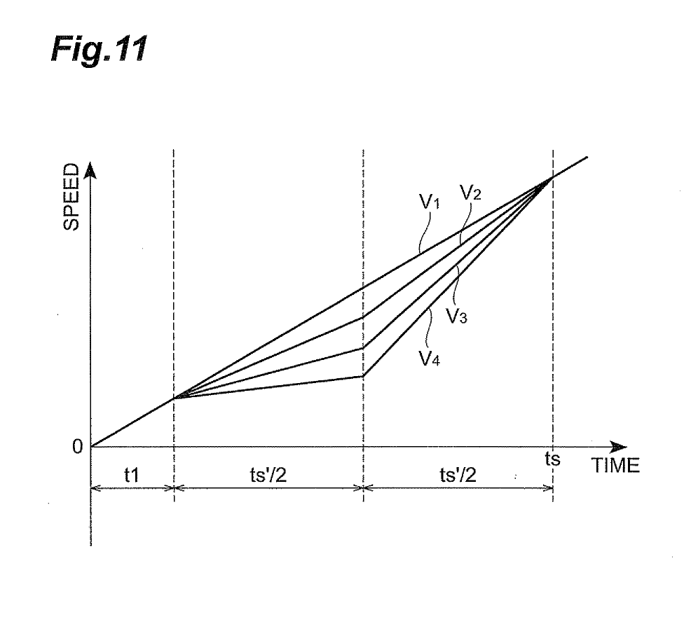

Thereafter, control is performed such that the front inter-vehicle distance Lₘ₋₁ of the host vehicle is maintained constant until the time t1 elapses. That is, the vehicle control ECU 10 fixes the target value of the front inter-vehicle distance Lₘ₋₁ constant until the time t1 elapses. Thereafter, when the time t1 has elapsed, t=0 is set. The subsequent processing is the same as S105 to S113 (see FIG. 3) in the vehicle group traveling control system 1, thus overlapping description will be omitted. Through the above-described processing by the vehicles C₁ to C₄, the variations in the vehicle speeds V₁ to V₄ of the vehicle C₁ to C₄ immediately after starting are as shown in FIG. 11.

[Processing Immediately Before Stopping]

When the variation Ls in the inter-vehicle distance and the variation time ts are given from an upper-level application or the like before stopping of the vehicle group, the vehicle control ECU 10 of the vehicle Cₘ changes the variation time ts to ts″ of Expression (4.2).

ts″=ts−t2 (4.2)

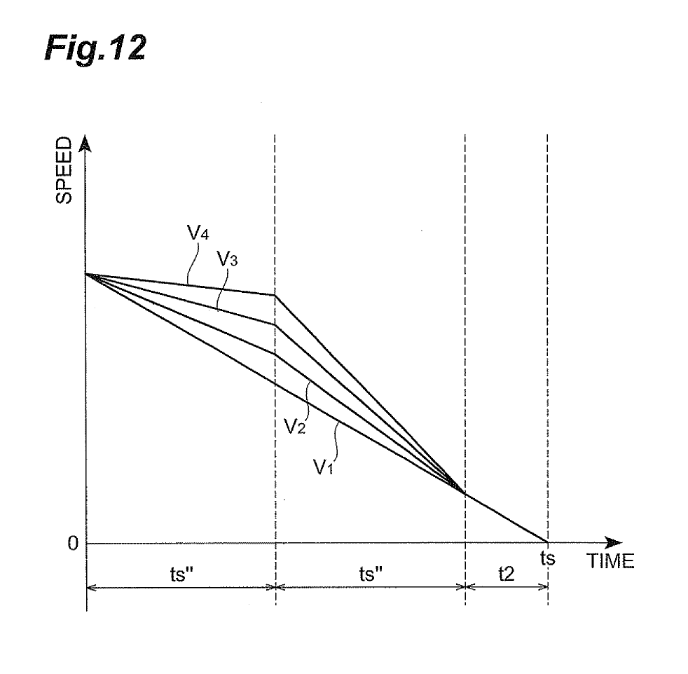

Thereafter, the same processing as S103 to S111 (see FIG. 3) in the vehicle group traveling control system 1 is performed and, after the relationship t>ts″ is established, the host vehicle is stopped while control is performed such that the front inter-vehicle distance Lₘ₋₁ of the host vehicle is maintained constant. That is, the vehicle control ECU 10 fixes the target value of the front inter-vehicle distance Lₘ₋₁ constant after the time t″. Through the above-described processing by the vehicles C₁ to C₄, the variations in the vehicle speeds V₁ to V₄ of the vehicles C₁ to C₄ immediately before stopping are as shown in FIG. 12.

Although the time zone when the inter-vehicle distances are fixed is determined on the basis of the time t1 and t2, when the vehicle speeds V₁ to V₄ of the vehicle group is lower than a predetermined value Va, the inter-vehicle distances may be fixed. In this case, the vehicle control ECU 10 calculates a time ta when the vehicle speeds V₁ to V₄ reach the predetermined value Va on the basis of the acceleration command value u_{ff} from an upper-level application or the like at the time of starting. The vehicle control ECU 10 also calculates a time tb when the vehicle speeds V₁ to V₄ reach the predetermined value Va on the basis of the acceleration command value u_{ff} from an upper-level application or the like at the time of stopping. The time ta and tb are respectively applied to the time t1 and t2, and the same processing as described above is performed. The predetermined value Va is set in advance as the lower limit value of the vehicle speed at which accurate acceleration/deceleration control of the vehicles C₁ to C₄ is easily performed and stored in advance in, for example, the information storage section 10a of the vehicle control ECU 10.

According to the vehicle including the above-described vehicle group traveling control system 401 and the vehicle group traveling control method, in a time zone immediately after starting, at which accurate acceleration/deceleration of the vehicles C₁ to C₄ is not easily carried out, comparatively easy control is performed such that the inter-vehicle distances are maintained constant, suppressing confusion of the timing of simultaneous starting or simultaneous stopping and confusion of the inter-vehicle distances of the vehicle group.

### Fifth Embodiment

Subsequently, a fifth embodiment of the vehicle and the vehicle group control method according to the invention will be described. The physical configuration of a vehicle group traveling control system 501 mounted in each of the vehicles C₁ to C₄ of this embodiment is the same as the vehicle group traveling control system 1, as shown in FIG. 1, thus overlapping description will be omitted.

As described above, in the vehicle group traveling control system 1, during the inter-vehicle distance changing step, a burden is likely to be more increasingly imposed on a vehicle at the rear of the vehicle group. In particular, as the number of vehicles forming the vehicle group increases, the problem noticeably appears. Thus, in the vehicle group traveling control system 501, the inter-vehicle distances L₁ to L₃ are changed one by one sequentially from the front. That is, the inter-vehicle distance L₂ starts to be changed immediately after the inter-vehicle distance L₁ has been changed, and the inter-vehicle distance L₃ starts to be changed immediately after the inter-vehicle distance L₂ has been changed.

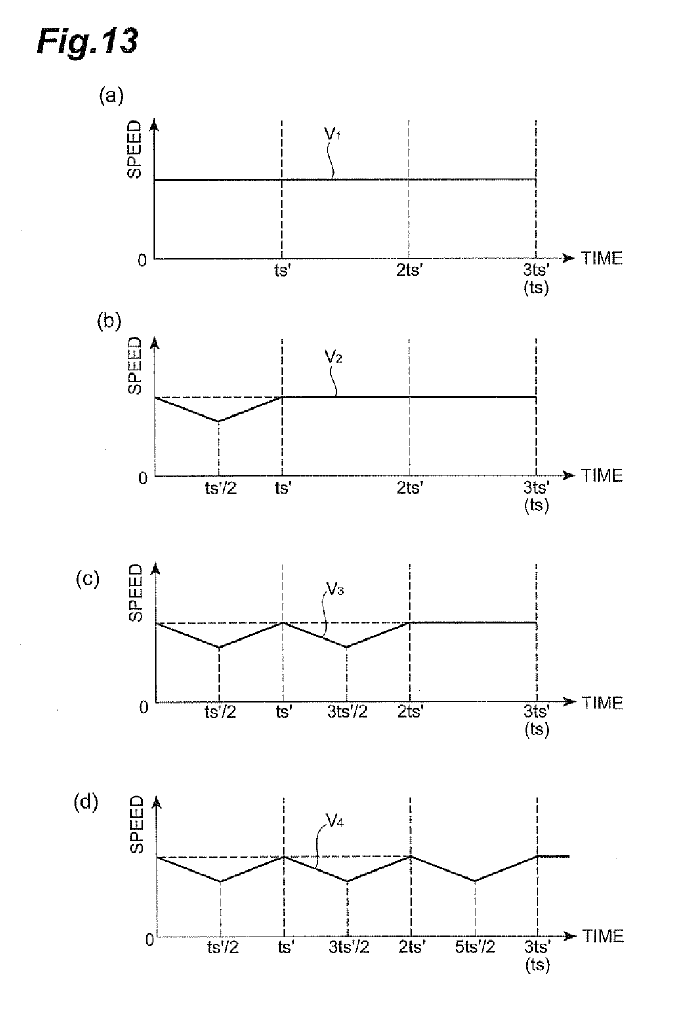

Specifically, in the step of extending the inter-vehicle distance, the target value variation patterns of the vehicles are determined such that the vehicle speeds V₁ to V₄ of the vehicles C₁ to C₄ are changed as indicated by graphs of FIGS. 13(a), (b), (c), and (d). With the variations in the vehicle speeds V₁ to V₄, the vehicle C₁ is traveling at a constant speed at t=0 to 3ts′. At t=0 to ts′, the vehicles C₂ to C₄ retreat while maintaining the inter-vehicle distances L₂ and L₃ with respect to the vehicle C₁, such that the inter-vehicle distance L₁ is extended. Next, at t=ts′ to 2ts′ immediately after the inter-vehicle distance L₁ has been changed, the vehicles C₃ and C₄ retreat while maintaining the inter-vehicle distance L₃ with respect to the vehicles C₁ and C₂, such that the inter-vehicle distance L₂ is extended. Finally, at t=2ts′ to 3ts′ immediately after the inter-vehicle distance L₂ has been changed, the vehicle C₄ retreats with respect to the vehicles C₁ to C₃, such that the inter-vehicle distance L₃ is extended. The above-described time ts′ is expressed by ts=3ts′ with respect to the variation time ts from an upper-level application or the like.

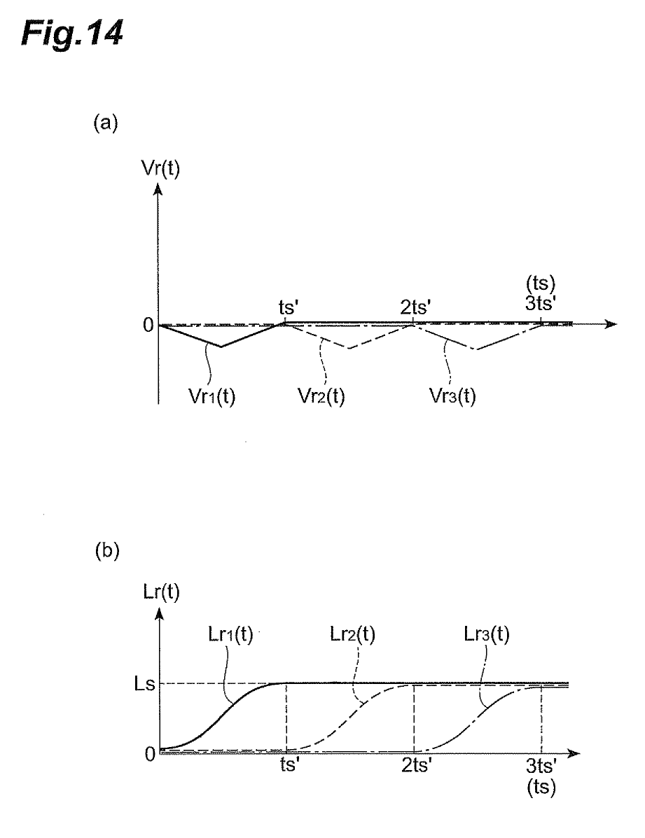

In realizing the variations in the vehicle speeds V₁ to V₄, the variation pattern of the target value Vrₘ(t) of the relative speed Vrₘ of each vehicle Cₘ at t=0 to ts differs between the vehicles and is as shown in FIG. 14(a). The graph of Vrₘ(t) of FIG. 14(a) is derived from the difference between the graph of Vₘ₊₁ and the graph of Vₘ in FIG. 13. The variation pattern of the target value Lrₘ(t) of the inter-vehicle distance Lₘ of each vehicle Cₘ also differs between the vehicles and is as shown in FIG. 14(b). The variation pattern of the target value arₘ(t) of the relative acceleration arₘ of each vehicle Cₘ also differs between the vehicles and is obtained by temporally differentiating the target value Vrₘ(t).

The vehicle group traveling control system 501 of each vehicle Cₘ performs control (S101 to S113 of FIG. 4) to extend the same front inter-vehicle distance Lₘ₋₁ as in the vehicle group traveling control system 1 using the variation patterns of the target values arₘ(t), Vrₘ(t), and Lrₘ(t) obtained in such a manner, instead of the target value variation patterns of FIGS. 4(a), (b), and (c). Such acceleration/deceleration control is performed in the vehicles C₂ to C₄, such that the variations in the vehicle speeds V₁ to V₄ shown in FIG. 13 are achieved. As shown in FIG. 14(a), the timing at which the relative speeds Vr₁ to Vr₃ reach the minimum peak becomes slower at the rear of the vehicle group.

According to the vehicle including the vehicle group traveling control system 501 and the vehicle group traveling control method described above, the inter-vehicle distances L₁ to Lₙ are changed one by one sequentially from the front of the vehicle group to the rear. Thus, even when the number n of vehicles forming the vehicle group is large, as understood from FIG. 13, there is no case where great acceleration/deceleration is necessary for a vehicle near to the tail of the vehicle group, reducing a burden of acceleration/deceleration on the vehicles.

Although the step of extending the inter-vehicle distance has been described, the same can be applied to the step of reducing the inter-vehicle distance. It should suffice that the signs of the vehicle speed Vₘ, the variation Lₛ, and the like are inverted. Thus, the variation patterns of the target values arₘ(t), Vrₘ(t), and Lrₘ(t) are obtained by vertically inverting the graphs of FIGS. 14(a) and (b) with respect to the time axis. With regard to the variations in the vehicle speeds V₁ to V₄ of the vehicles, the graphs of FIGS. 13(a) to (d) are vertically inverted with respect to the time axis. In this case, the timing at which the relative speeds Vr₁ to Vr₃ reach the maximum peak becomes slower at the rear of the vehicle group. Therefore, even in the step of reducing the inter-vehicle distance, there is no case where great acceleration/deceleration is necessary for a vehicle near the tail of the vehicle group, reducing a burden of acceleration/deceleration on the vehicles.

### Sixth Embodiment

Subsequently, a sixth embodiment of the vehicle and the vehicle group control method according to the invention will be described. The physical configuration of a vehicle group traveling control system 601 mounted in each of the vehicles C₁ to C₄ of this embodiment is the same as the vehicle group traveling control system 1, as shown in FIG. 1, thus overlapping description will be omitted.

Although in the above-described vehicle group traveling control system 501, it is possible to reduce a burden on a vehicle at the rear of the vehicle group during the inter-vehicle distance changing step, a problem still remains in that the variation time is extended in proportion to the number of inter-vehicle distances. As shown in FIGS. 13(c) and (d), the succeeding vehicles C₃ and C₄ alternately repeat acceleration and deceleration multiple times, causing unsatisfactory efficiency. In particular, as the number of vehicles forming the vehicle group increases, such problems noticeably appear.

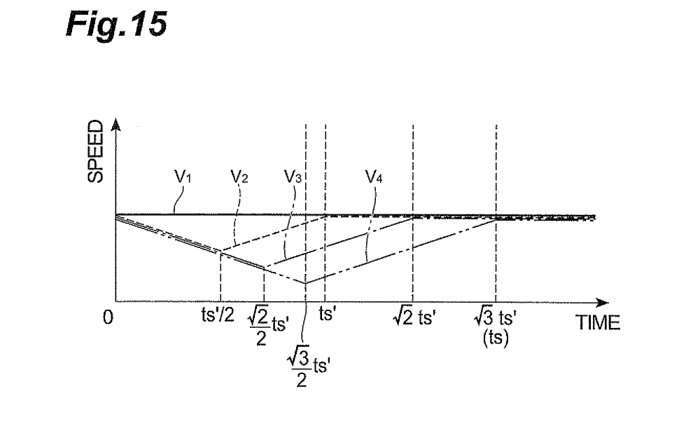

Thus, in the vehicle group traveling control system 601, the relative movement of the succeeding vehicles C₂, C₃, and C₄ with respect to the leading vehicle C₁ is started simultaneously, and acceleration/deceleration switching of the succeeding vehicles C₂, C₃, and C₄ is started one by one sequentially from the front such that the timing of switching acceleration/deceleration becomes slower in the succeeding vehicles. Specifically, the target value variation patterns of the vehicles are determined such that the vehicle speeds V₁ to V₄ of the vehicles C₁ to C₄ are changes as indicated by the graphs of FIG. 15 during the step of extending the inter-vehicle distance.

With the variations in the vehicle speeds V₁ to V₄, the leading vehicle C₁ is traveling at a constant speed at the time t=0 to √(3)·ts′. At the time t=0 to ts′/2, the succeeding vehicles C₂ to C₄ are decelerated at the same deceleration. Thereafter, at the time t=ts′/2, the vehicle C₂ is switched to acceleration, at the time t=√(2)·ts′/2, the vehicle C₃ is switched to acceleration, and at the time t=√(3)·ts′/2, the vehicle C₄ is switched to acceleration. The acceleration of each of the succeeding vehicles C₂ to C₄ ends when the vehicle speed reaches the vehicle speed V₁ of the leading vehicle C₁. The above-described time ts′ is expressed by ts=√(3)·ts′ with respect to the variation time ts from an upper-level application or the like.

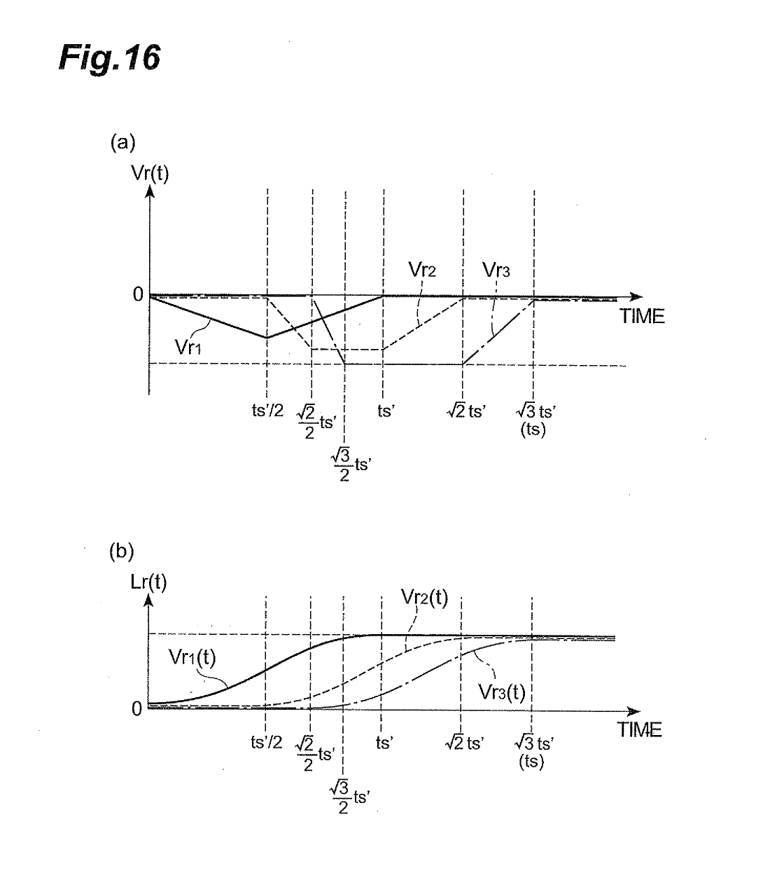

In realizing the variations in the vehicle speeds V₁ to V₄, the variation pattern of the target value Vrₘ(t) of the relative speed Vrₘ of each vehicle Cₘ at t=0 to ts differs between the vehicles and is as shown in FIG. 16(a). The graph of Vrₘ(t) of FIG. 16(a) is derived from the difference between the graph of Vₘ₊₁ and the graph of Vₘ in FIG. 15. As shown in FIG. 16, the target value Vr₁(t) reaches the minimum peak at the time t=ts′/2, the target value Vr₂(t) reaches the minimum peak at the time t=√(2)·ts′/2, and the target value Vr₃(t) reaches the minimum peak at the time t=√(3)ts′/2. Therefore, with the variations in the vehicle speeds V₁ to V₄ described above, it is determined that the timing at which the relative speed with respect to the preceding vehicle reaches the minimum peak becomes slower in the succeeding vehicles. As shown in FIG. 15, the time for which the vehicle speed returns to the same vehicle speed V₁ as the leading vehicle C₁ becomes slower.

The variation pattern of the target value Lrₘ(t) of the inter-vehicle distance Lₘ of each vehicle Cₘ also differs between the vehicles and is as shown in FIG. 16(b). The variation pattern of the target value arₘ(t) of the relative acceleration arₘ of each vehicle Cₘ also differs between the vehicles and is obtained by temporally differentiating the target value Vrₘ(t).

The vehicle group traveling control system 601 of each vehicle Cₘ performs control (S101 to S113 of FIG. 4) to extend the same front inter-vehicle distance Lₘ₋₁ using the variation patterns of the target values arₘ(t), Vrₘ(t), and Lrₘ(t) obtained in such a manner, instead of the target value variation patterns of FIGS. 4(a), (b), and (c). Such acceleration/deceleration control is performed by the vehicles C₂ to C₄, achieving the variations in the vehicle speeds V₁ to V₄ shown in FIG. 13.

Specifically, the time t₀ₘ when the inter-vehicle distance between the vehicle Cₘ₋₁ and the vehicle Cₘ starts to be changed is expressed by Expression (6.1), the maximum value Vₘ′ of the relative speed between the vehicle Cₘ₋₁ and the vehicle Cₘ is expressed by Expression (6.2), the time t₁ₘ when the relative speed Vrₘ starts to decrease is expressed by Expression (6.3), and the time t₂ₘ when the inter-vehicle distance Lₘ ends to be changed is expressed by Expression (6.4).

$$\begin{matrix}[ Equation 1 ] & \\ {t}_{0 m} = \frac{\sqrt{m - 1}}{2} \times {ts}^{′} & ( 6.1 ) \\ {Vr}_{m}^{′} = \frac{4}{\sqrt{m} - \sqrt{m - 1}} \times \frac{Ls}{{ts}^{′}} & ( 6.2 ) \\ {t}_{1 m} = \sqrt{m - 1} \times {ts}^{′} & ( 6.3 ) \\ {t}_{2 m} = \sqrt{m} \times {ts}^{′} & ( 6.4 )\end{matrix}$$

According to the vehicle including the vehicle group traveling control system 501 and the vehicle group traveling control method described above, the succeeding vehicles C₂ to C₄ start to be decelerated simultaneously with respect to the leading vehicle C₁, are switched to acceleration sequentially from the succeeding vehicle at the front, and return to the same vehicle speed V₁ as the leading vehicle C₁. In this case, since the succeeding vehicles C₂ to C₄ initially start to be decelerated simultaneously, all the inter-vehicle distances L₁ to L₃ can be changed simultaneously to some extent, and the inter-vehicle distances can be changed comparatively quickly. Although the relative movement distance with respect to the leading vehicle C₁ more increases in a vehicle at the rear, the switching timing from deceleration to acceleration is slower in a vehicle at the rear. For this reason, the movement time is long, and there is no case where great acceleration/deceleration is forced in a succeeding vehicle. It should suffice that the succeeding vehicles C₂ to C₄ are switched from deceleration to acceleration once only, achieving satisfactory efficiency. That is, from the viewpoint that the variation time is can be more reduced and there is no repetitive acceleration/deceleration of the succeeding vehicles C₂ to C₄, the vehicle group traveling control system 601 is excellent compared to the vehicle group traveling control system 501.

Although the step of extending the inter-vehicle distance has been described, the same can be applied to the step of reducing the inter-vehicle distance. It should suffice that the signs of the vehicle speed Vₘ, the variation Lₛ, and the like are inverted. For this reason, the target value variation patterns are obtained by vertically inverting the graphs of FIGS. 16(a) and (b) with respect to the time axis. In this case, as determined by vertically inverting the graph of FIG. 16(a), the timing at which the relative speed with respect to the preceding vehicle reaches the maximum peak is slower in a vehicle at the rear. With regard to the variations in the vehicle speeds V₁ to V₄ of the vehicles, the graph of FIG. 15 is inverted vertically with respect to the time axis. Thus, the succeeding vehicles C₂ to C₄ start to be accelerated simultaneously with respect to the leading vehicle C₁, are switched to deceleration sequentially from the succeeding vehicle at the front, and sequentially return to the same vehicle speed V₁ as the leading vehicle C₁. That is, the time at which the vehicle speed returns to the same vehicle speed V₁ as the leading vehicle C₁ is slower in a vehicle at the rear. As a result, even in the step of reducing the inter-vehicle distance, similarly to the step of extending the inter-vehicle distance, the inter-vehicle distance can be changed comparatively quickly, and there is no case where great acceleration/deceleration is forced in the vehicles at the rear. It should suffice that the succeeding vehicles C₂ to C₄ are switched from acceleration to deceleration once only, achieving satisfactory efficiency.

The invention is not limited to the foregoing first to fifth embodiments. For example, although in the first to sixth embodiments, the vehicle group traveling control systems provided in the vehicles C₁ to C₄ separately perform arithmetic processing in parallel, the vehicle group traveling control system of one of the vehicles C₁ to C₄ may perform the arithmetic processing to calculate the acceleration command values u₁ to u₄ and distribute the arithmetic result to other vehicles through vehicle-to-vehicle communication. However, the method in which the vehicle group traveling control systems provided in the vehicles C₁ to C₄ separately perform the arithmetic processing is excellent from the viewpoint that there is no delay according to vehicle-to-vehicle communication. The vehicle group traveling control systems provided in the vehicles C₁ to C₄ may separately perform the arithmetic processing, exchange the arithmetic results with each other through vehicle-to-vehicle communication, and crosscheck the arithmetic results.

Although in the first to sixth embodiments, an example has been described where vehicle group traveling of the four vehicles C₁ to C₄ is performed, it will be obvious that vehicle group traveling control of the first to sixth embodiments is not limited to four vehicles, and vehicle group traveling of an arbitrary number of vehicles can be realized.

### INDUSTRIAL APPLICABILITY

The invention relates to a vehicle group control method which controls traveling of a vehicle group having a plurality of vehicles and to a vehicle including vehicle group control means, having an advantage of accurately changing the inter-vehicle distance with smooth variations in the relative vehicle speed.

### REFERENCE SIGNS LIST

1: vehicle group traveling control system (vehicle group control means), C₁ to C₄: vehicle, C₁: leading vehicle, C₄: trailing vehicle, L₁ to L₃: inter-vehicle distance, V₁ to V₄: vehicle speed, Vr₁ to Vr₃: relative speed, Z: reference position.

1-16. (canceled)

17. A vehicle group control method which controls traveling of a vehicle group having n vehicles (where n=2, 3, . . . ),
wherein, in extending the inter-vehicle distance between a (j−1)th vehicle from the front and a j-th vehicle (where j=2, 3, . . . , n) within the vehicle group, a target inter-vehicle distance between the (j−1)th vehicle and the j-th vehicle during the changing of the inter-vehicle distance is changed in accordance with the variation pattern of a target inter-vehicle distance based on a variation in the inter-vehicle distance to be changed and a variation time necessary for changing the inter-vehicle distance, and
during the changing of the inter-vehicle distance, the relative speed of the j-th vehicle with respect to the (j−1)th vehicle corresponding to the temporal variation rate of the target inter-vehicle distance is changed as indicated by a graph with a minimum value on a time axis.

18. A vehicle group control method which controls traveling of a vehicle group having n vehicles (where n=2, 3, . . . ),
wherein, in reducing the inter-vehicle distance between a (j−1)th vehicle from the front and a th vehicle (where j=2, 3, . . . , n) within the vehicle group, a target inter-vehicle distance between the (j−1)th vehicle and the j-th vehicle during the changing of the inter-vehicle distance is changed in accordance with the variation pattern of a target inter-vehicle distance based on a variation in the inter-vehicle distance to be changed and a variation time necessary for changing the inter-vehicle distance, and
during the changing of the inter-vehicle distance, the relative speed of the j-th vehicle with respect to the (j−1)th vehicle corresponding to a temporal variation rate of the target inter-vehicle distance is changed as indicated by a graph with a maximum value on a time axis.

19. A vehicle group control method which controls traveling of a vehicle group having n vehicles (where n=2, 3, . . . ),
wherein, in extending the inter-vehicle distance between a (j−1)th vehicle from the front and a j-th vehicle (where j=2, 3, . . . , n) within the vehicle group, the relative speed of the j-th vehicle with respect to the (j−1)th vehicle during the changing of the inter-vehicle distance is changed as indicated by a graph with a minimum value on a time axis, and
in changing all the inter-vehicle distances within the vehicle group by a predetermined variation, the time for changing the inter-vehicle distance is determined on the basis of the number of vehicles, the predetermined variation, and the vehicle speed of a leading vehicle of the vehicle group.

20. A vehicle group control method which controls traveling of a vehicle group having n vehicles (where n=2, 3, . . . ),
wherein, in extending the inter-vehicle distance between a (j−1)th vehicle from the front and a j-th vehicle (where j=2, 3, . . . , n) within the vehicle group, the relative speed of the j-th vehicle with respect to the (j−1)th vehicle during the changing of the inter-vehicle distance is changed as indicated by a graph with a minimum value on a time axis, and
in extending the inter-vehicle distance within the vehicle group,
in a vehicle before a predetermined reference position between the leading vehicle and the trailing vehicle of the vehicle group, the vehicle speed during the changing of the inter-vehicle distance of the relevant vehicle is changed as indicated by a graph with a maximum value on a time axis, and
in a vehicle behind the predetermined reference position, the vehicle speed during the changing of the inter-vehicle distance of the relevant vehicle is changed as indicated by a graph with a minimum value on a time axis.

21. A vehicle group control method which controls traveling of a vehicle group having n vehicles (where n=2, 3, . . . ),
wherein, in reducing the inter-vehicle distance between a (j−1)th vehicle from the front and a j-th vehicle (where j=2, 3, . . . , n) within the vehicle group, the relative speed of the j-th vehicle with respect to the (j−1)th vehicle during the changing of the inter-vehicle distance is changed as indicated by a graph with a maximum value on a time axis, and
in reducing the inter-vehicle distance within the vehicle group,
in a vehicle before a predetermined reference position between the leading vehicle and the trailing vehicle of the vehicle group, the vehicle speed during the changing of the inter-vehicle distance of the relevant vehicle is changed as indicated by a graph with a minimum value on a time axis, and
in a vehicle behind the predetermined reference position, the vehicle speed during the changing of the inter-vehicle speed of the relevant vehicle is changed as indicated by a graph with a maximum value on a time axis.

22. The vehicle group control method according to claim 17,
wherein, when the vehicle speed of the vehicle group before the changing of the inter-vehicle distance is zero, all target inter-vehicle distances of the vehicle group are fixed within a predetermined time after the start of changing the inter-vehicle distance, and
when the vehicle speed of the vehicle group after the inter-vehicle distance has been changed is set to zero, all target inter-vehicle distances of the vehicle group are fixed within a predetermined time before the end of changing the inter-vehicle distance.

23. The vehicle group control method according to claim 17,
wherein, when the vehicle speed of the vehicle group is lower than a predetermined value, all target inter-vehicle distances of the vehicle group are fixed.

24. A vehicle group control method which controls traveling of a vehicle group having n vehicles (where n=2, 3, . . . ),
wherein, in extending the inter-vehicle distance between a (j−1)th vehicle from the front and a j-th vehicle (where j=2, 3, . . . , n) within the vehicle group, the relative speed of the j-th vehicle with respect to the (j−1)th vehicle during the changing of the inter-vehicle distance is changed as indicated by a graph with a minimum value on a time axis, and
in changing all the inter-vehicle distances within the vehicle group, changing the inter-vehicle distance between a k-th vehicle from the front and a (k+1)th vehicle (where k=2, 3, . . . , n−1) within the vehicle group starts immediately after changing the inter-vehicle distance between a (k−1)th vehicle and the k-th vehicle within the vehicle group has been completed.

25. A vehicle group control method which controls traveling of a vehicle group having n vehicles (where n=2, 3, . . . ),
wherein, in extending the inter-vehicle distance between a (j−1)th vehicle from the front and a j-th vehicle (where j=2, 3, . . . , n) within the vehicle group, the relative speed of the j-th vehicle with respect to the (j−1)th vehicle during the changing of the inter-vehicle distance is changed as indicated by a graph with a minimum value on a time axis, and
in changing the inter-vehicle distance within the vehicle group, the relative speed of each vehicle is changed such that the timing when the relative speed reaches a peak becomes slower in a vehicle at the rear of the vehicle group.

26. A vehicle group control method which controls traveling of a vehicle group having n vehicles (where n=2, 3, . . . ),
wherein, in extending the inter-vehicle distance between a (j−1)th vehicle from the front and a j-th vehicle (where j=2, 3, . . . , n) within the vehicle group, the relative speed of the j-th vehicle with respect to the (j−1)th vehicle during the changing of the inter-vehicle distance is changed as indicated by a graph with a minimum value on a time axis,
in extending all the inter-vehicle distances within the vehicle group, for all succeeding vehicles other than the leading vehicle of the vehicle group, after deceleration has been started simultaneously with respect to the leading vehicle, the succeeding vehicles are switched to acceleration at respective switching timings and accelerated until the vehicle speed becomes equal to the vehicle speed of the leading vehicle, and
the switching timing becomes slower in a vehicle at the rear of the vehicle group.

27. A vehicle group control method which controls traveling of a vehicle group having n vehicles (where n=2, 3, . . . ),
wherein, in reducing the inter-vehicle distance between a (j−1)th vehicle from the front and a j-th vehicle (where j=2, 3, n) within the vehicle group, the relative speed of the j-th vehicle with respect to the (j−1)th vehicle during the changing of the inter-vehicle distance is changed as indicated by a graph with a maximum value on a time axis,
in reducing all the inter-vehicle distances within the vehicle group, for all succeeding vehicles other than the leading vehicle of the vehicle group, after acceleration has been started simultaneously with respect to the leading vehicle, the succeeding vehicles are switched to deceleration at respective switching timings and decelerated until the vehicle speed becomes equal to the vehicle speed of the leading vehicle, and
the switching timing becomes slower in a vehicle at the rear of the vehicle group.

28. A vehicle comprising:
vehicle group control means for controlling traveling of a vehicle group having n vehicles (where n=2, 3, . . . ),
wherein, in extending the inter-vehicle distance between a (j−1)th vehicle from the front and a j-th vehicle (where j=2, 3, . . . , n) within the vehicle group, the vehicle control means changes a target inter-vehicle distance between the (j−1)th vehicle and the j-th vehicle during the changing of the inter-vehicle distance in accordance with the variation pattern of a target inter-vehicle distance based on a variation in the inter-vehicle distance to be changed and a variation time necessary for changing the inter-vehicle distance, and
during the changing of the inter-vehicle distance, the vehicle group control means changes the relative speed of the j-th vehicle with respect to the (j−1)th vehicle corresponding to the temporal variation rate of the target inter-vehicle distance as indicated by a graph with a minimum value on a time axis.

29. A vehicle comprising:
vehicle group control means for controlling traveling of a vehicle group having n vehicles (where n=2, 3, . . . ),
wherein, in reducing the inter-vehicle distance between a (j−1)th vehicle from the front and a j-th vehicle (where j=2, 3, n) within the vehicle group, the vehicle group control means changes a target inter-vehicle distance between the (j−1)th vehicle and the j-th vehicle during the changing of the inter-vehicle distance in accordance with the variation pattern of a target inter-vehicle distance based on a variation in the inter-vehicle distance to be changed and a variation time necessary for changing the inter-vehicle distance, and
during the changing of the inter-vehicle distance, vehicle group control means changes the relative speed of the j-th vehicle with respect to the (j−1)th vehicle corresponding to a temporal variation rate of the target inter-vehicle distance as indicated by a graph with a maximum value on a time axis.

30. A vehicle group control method which controls traveling of a vehicle group having n vehicles (where n=2, 3, . . . ),
wherein, in reducing the inter-vehicle distance between a (j−1)th vehicle from the front and a j-th vehicle (where j=2, 3, . . . , n) within the vehicle group, the relative speed of the j-th vehicle with respect to the (j−1)th vehicle during the changing of the inter-vehicle distance is changed as indicated by a graph with a maximum value on a time axis, and
in changing all the inter-vehicle distances within the vehicle group by a predetermined variation, the time for changing the inter-vehicle distance is determined on the basis of the number of vehicles, the predetermined variation, and the vehicle speed of a leading vehicle of the vehicle group.

31. A vehicle group control method which controls traveling of a vehicle group having n vehicles (where n=2, 3, . . . ),
wherein, in reducing the inter-vehicle distance between a (j−1)th vehicle from the front and a j-th vehicle (where j=2, 3, . . . , n) within the vehicle group, the relative speed of the j-th vehicle with respect to the (j−1)th vehicle during the changing of the inter-vehicle distance is changed as indicated by a graph with a maximum value on a time axis, and
in changing all the inter-vehicle distances within the vehicle group, changing the inter-vehicle distance between a k-th vehicle from the front and a (k+1)th vehicle (where k=2, 3, . . . , n−1) within the vehicle group starts immediately after changing the inter-vehicle distance between a (k−1)th vehicle and the k-th vehicle within the vehicle group has been completed

32. A vehicle group control method which controls traveling of a vehicle group having n vehicles (where n=2, 3, . . . ),
wherein, in reducing the inter-vehicle distance between a (j−1)th vehicle from the front and a j-th vehicle (where j=2, 3, . . . , n) within the vehicle group, the relative speed of the j-th vehicle with respect to the (j−1)th vehicle during the changing of the inter-vehicle distance is changed as indicated by a graph with a maximum value on a time axis, and
in changing the inter-vehicle distance within the vehicle group, the relative speed of each vehicle is changed such that the timing when the relative speed reaches a peak becomes slower in a vehicle at the rear of the vehicle group.

33. The vehicle group control method according to claim 18,
wherein, when the vehicle speed of the vehicle group before the changing of the inter-vehicle distance is zero, all target inter-vehicle distances of the vehicle group are fixed within a predetermined time after the start of changing the inter-vehicle distance, and
when the vehicle speed of the vehicle group after the inter-vehicle distance has been changed is set to zero, all target inter-vehicle distances of the vehicle group are fixed within a predetermined time before the end of changing the inter-vehicle distance.

34. The vehicle group control method according to claim 18,
wherein, when the vehicle speed of the vehicle group is lower than a predetermined value, all target inter-vehicle distances of the vehicle group are fixed.
